(19) United States
(12) Patent Application Publication
(10) Pub. No.: US 2003/0224214 A1
(43) Pub. Date: Dec. 4, 2003

(54) Magneto-optic polymer nanocomposites

(76) Inventors: Anthony F. Garito, Radnor, PA (US); Renyuan Gao, Wayne, PA (US); Renfeng Gao, Phoenixville, PA (US); Yu-Ling Hsiao, Collegeville, PA (US); Brian Thomas, Exton, PA (US)

Correspondence Address: Finnegan, Henderson, Farabow,, Garrett & Dunner, L.L.P., 1300 I Street, N.W., Washington, DC, 20005-3315, US

(21) Appl. No.: 10/388,543

(22) Filed: Mar. 17, 2003

Related U.S. Application Data
(60) Provisional application No. 60/364,043, filed on Mar. 15, 2002.
(60) Provisional application No. 60/364,132, filed on Mar. 15, 2002.

(51) Int. Cl. G11B 5/66

(52) U.S. Cl. 428/694 ML; 428/694 R

(57) ABSTRACT

The present invention relates to composite materials comprising a host matrix, and a plurality of magneto-optic nanoparticles within the host matrix, a process of forming a composite material comprising coating a plurality of magneto-optic nanoparticles with at least one polymer layer, and dispersing the plurality of coated nanoparticles into a host matrix material, and thin-film magneto-optic articles, and optical components, such as integrated optical components, as well as optical devices, such as optical rotators, such as Faraday rotators, optical isolators, optical circulators, optical modulators, waveguides, and amplifiers, comprising the composite material according to the present invention.

### CROSS-REFERENCE TO RELATED APPLICATIONS

This application claims the benefit of priority under 35 U.S.C. § 119(e) to U.S. Provisional Application Nos. 60/364,043 and 60/364,132 filed Mar. 15, 2002.

### FIELD OF THE INVENTION

The present invention generally relates to magneto-optic materials. More specifically, the present invention relates to polymer composite magneto-optic materials comprising nanoparticles.

### BACKGROUND OF THE INVENTION

A typical optical fiber transmission line contains numerous optical components. Reflected optical signals commonly occur from the input and output faces of these components and can have adverse effects on overall signal transmission performance along the line. Optical isolators, which comprise a magneto-optical material possessing a Faraday effect, can allow light in the forward propagation direction of the transmission line, but block light propagating in the backward direction. Thus, optical isolators are critical components in the transmission line for controlling and managing destabilizing effects of backward reflected light beams.

Further, optical isolators, commonly realized in the form of bulky inorganic single crystals, as opposed to thin films or fibers, are nearly universally based on transparent single crystals of various paramagnetic inorganic rare earth compounds such as oxides, phosphates, vanadates, and various metal oxides, for example, crystals containing terbium, yttrium, or cerium ions (Tb⁺³, Y⁺³, or Ce⁺³, respectively). However, it is highly desirable to realize and deploy optical isolators in integrated optical circuits. For certain applications, discrete optical components and modules that contain Faraday rotators in the form of transparent optical thin films are required. Thus, versatile Faraday rotators fabricated in the form of thin film magneto-optic articles would prove novel and advantageous for device design, fabrication, operation, and performance. While optical isolators, commonly realized in the form of bulky inorganic single crystals, can represent a limitation.

A general solution to the limitation is provided by composite materials. These materials are well known, and generally comprise two or more materials each offering its own set of properties or characteristics. The two or more materials may be joined together to form a system that exhibits properties derived from each of the materials. A common form of a composite is one with a body of a first material (a host matrix) with a second material distributed in the host matrix.

One class of composite materials includes nanoparticles distributed within a host matrix material. Nanoparticles are particles of a material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range. For example, particles having a size as small as about 1 nm and as large as about 1×10³ nm could still be considered nanoparticles. Nanoparticles can be made from a wide array of materials. Among these materials examples include, transition metals, rare-earth metals, group VA elements, polymers, dyes, semiconductors, alkaline earth metals, alkali metals, group IIIA elements, and group IVA elements.

Further, nanoparticles themselves may be considered a nanoparticle composite, which may comprise a wide array of materials, single elements, mixtures of elements, stoichiometric or non-stoichiometric compounds. The materials may be crystalline, amorphous, or mixtures, or combinations of such structures.

The host matrix may comprise a random glassy matrix such as an amorphous organic polymer. Organic polymers may include typical hydrocarbon polymers and halogenated polymers. It is generally desirable that in an optical component, such as a planar optical waveguide, thin film, and fiber, the total optical loss be kept at a minimum. For example, in the case of a planar optical wavegide, the total loss should be approximately equal to, or less than, 0.5 dB/cm in magnitude, and such as less than 0.2 dB/cm. For a highly transparent optical medium to be used as the optical material, a fundamental requirement is that the medium exhibits little, or no, absorption and scattering losses.

Intrinsic absorption losses commonly result from the presence of fundamental excitations that are electronic, vibrational, or coupled electronic-vibrational modes in origin. Further, the device operating wavelength of the optical component should remain largely different from the fundamental, or overtone, wavelengths for these excitations. Further, these absorptive overtones can cause the hydrocarbon polymers to physically or chemically degrade, thereby leading to additional and often times permanent increase in signal attenuation in the optical fibers or waveguides.

Material scattering losses occur when the signal wave encounters abrupt changes in refractive index of the otherwise homogeneous uniform optical medium. These discontinuities can result from the presence of composition inhomogenieties, crystallites, nanoporous structures, voids, fractures, stresses, faults, or even foreign impurities such as dust or other particulates.

Among the various mechanisms of optical scattering loss, an important factor is the porosity of the optical material. As a result of the interplay between various material characteristics, e.g., surface energy, solubility, glass transition temperature, entropy, etc., and processing conditions, e.g., temperature, pressure, atmosphere, etc., optical materials, such as amorphous perfluoropolymers can exhibit a large amount of nanoporous structures under normal processing conditions. Such nanoporous structures can cause optical scattering loss and should be eliminated, or converted to smaller sizes, in order to satisfy a certain low optical loss device performance requirement. The smaller sized pores are called nanopores. Nanopores are pores in a material that have a size measured on a nanometer scale. Generally, nanopores are larger than the size of an atom but smaller than 1000 nm. While most nanopores have a size from about 1 nm to about 500 nm, the term nanopores can cover pores having sizes that fall outside of this range. For example, pores having a size as small as about 0.5 nm and as large as about 1×10³ nm could still be considered nanopores.

By introducing nanoparticles into an optically transparent host matrix, realized, for example, by an amorphous random glassy polymer, the absorption and scattering losses due to the nanoparticles may add to the optical loss. In order to keep the optical loss to a minimum, in addition to controlling the loss contribution from the host matrix, it is essential to control the absorption and scattering loss from the nanoparticles doped into the host matrix for optical applications.

For discrete nanoparticles that are approximately spherical in shape and doped into the host matrix, the scattering loss α, in dB per unit length, resulting from the presence of the particles is dependent on the particle diameter d, the refractive index ratio of the nanoparticles and the waveguide core m=nₚₐᵣ/n_{core}, and the volume fraction of the nanoparticles in the host waveguide core Vₚ. The nanoparticle induced scattering loss can be calculated by:

$$α = 1.692 \times {10}^{3} {( \frac{{m}^{2} - 1}{{m}^{2} + 2} )}^{2} \frac{{d}^{3} {V}_{p}}{{λ}^{4}} \qquad ( 1 )$$

wherein λ is the vacuum propagation wavelength of the light guided inside the waveguide. As an example, when m=2, Vₚ=10%, λ=1550 nm, d=10 nm, the calculated scattering loss α is 0.07 dB/cm. To fabricate a certain waveguide device with a set loss specification, and therefore a nanoparticle induced waveguide loss budget of α, the nanoparticle diameter d must satisfy the following equation relationships:

$$d < {( α \frac{1}{1.692 \times {10}^{3}} {( \frac{{m}^{2} + 2}{{m}^{2} - 1} )}^{2} \frac{{λ}^{4}}{{V}_{p}} )}^{1 / 3} \qquad ( 2 )$$

wherein λ is the vacuum propagation wavelength of the light guided inside the waveguide, m=nₚₐᵣ/n_{core} the refractive index ratio of the nanoparticles and the core, and Vₚ the volume fraction of the nanoparticles in the host waveguide core. For example, following Equation 2, with a nanoparticle loss budget of α=0.5 dB/cm, when m=2, Vₚ=10%, λ=1550 nm, the nanoparticle diameter d must be smaller than 19 nm. In general, the diameter of the nanoparticles must be smaller than about 50 nm, such as 20 nm.

The description for nanoparticle loss also can be applied to nanopore contributions to propagation loss by representing the nanopores as equivalent nanoparticles with refractive index of 1.

Composite materials including nanoparticles distributed within a host matrix material have been used in optical applications. For example, U.S. Pat. No. 5,777,433 (the '433 patent) discloses a light emitting diode (LED) that includes a packaging material including a plurality of nanoparticles distributed within a host matrix material. The nanoparticles increase the index of refraction of the host matrix material to create a packaging material that is more compatible with the relatively high refractive index of the LED chip disposed within the packaging material. Because the nanoparticles do not interact with light passing through the packaging material, the packaging material remains substantially transparent to the light emitted from the LED.

While the packaging material used in the '433 patent offers some advantages derived from the nanoparticles distributed within the host matrix material, the composite material of the '433 patent remains problematic. For example, the composite material of the '433 patent includes glass or ordinary hydrocarbon polymers, such as epoxy and plastics, as the host matrix material. While these materials may be suitable in certain applications, they limit the capabilities of the composite material in many other areas. For example, the host matrix materials of the '433 patent commonly exhibit high absorption losses.

Moreover, the method of the '433 patent is problematic in not accounting for optical scattering loss from relatively large nanopores or nanoporous structures. In fact, among the various mechanisms of optical scattering loss, an important factor is the porosity of the optical material. As a result of the interplay between various material characteristics, e.g., surface energy, solubility, glass transition temperature, entropy, etc., and processing conditions, e.g., temperature, pressure, atmosphere, etc., optical materials, such as amorphous perfluoropolymers, can exhibit a large amount of nanoporous structures under normal processing conditions. Such nanoporous structures can cause optical scattering loss and should be eliminated, or converted to smaller sizes, in order to satisfy a certain low optical loss device performance requirement. By controlling the pore sizes and pore structures, optical scattering losses can be greatly reduced. The method of the '433 patent does not recognize the presence of discrete pores or porous structure nor teach control of their sizes and structures.

Additionally, the method of the '433 patent for dealing with agglomeration of the nanoparticles within the host matrix material is inadequate for many composite material systems. Agglomeration is a significant problem when making composite materials that include nanoparticles distributed within a host matrix material. Because of the small size and great numbers of nanoparticles that may be distributed within a host matrix material, there is a large amount of interfacial surface area between the surfaces of the nanoparticles and the surrounding host matrix material. As a result, the nanoparticle/host-matrix material system operates to minimize this interfacial surface area, and corresponding surface energy, by combining the nanoparticles together to form larger particles. This process is known as agglomeration. Once the nanoparticles have agglomerated within a host matrix material, it is extremely difficult to separate the agglomerated particles back into individual nanoparticles.

Agglomeration of the nanoparticles within the host matrix material may result in a composite material that lacks a desired characteristic. Specifically, when nanoparticles agglomerate together, the larger particles formed may not behave in a similar way to the smaller nanoparticles. For example, while nanoparticles may be small enough to avoid scattering light within the composite material, agglomerated particles may be sufficiently large to cause scattering. As a result, a host matrix material may become substantially less transparent in the presence of such agglomerated particles.

To combat agglomeration, the composite material of the '433 patent includes an anti-flocculant coating disposed on the nanoparticles intended to inhibit agglomeration. Specifically, the '433 patent suggests using surfactant organic coatings to suppress agglomeration. These types of coatings, however, may be inadequate or ineffective especially when used with host matrix materials other than typical hydrocarbon polymers.

As a result, there is a need for materials and composites that can overcome at least one of the above-described problems or disadvantages of the prior art.

The present invention is directed to overcoming at least one of the problems or disadvantages associated with the prior art.

### SUMMARY OF THE INVENTION

The present invention relates to nanocomposite magneto-optic materials. The present invention further relates to composite materials comprising a host matrix, and a plurality of magneto-optic nanoparticles within the host matrix. In one embodiment, the magneto-optic nanoparticles can be bare, coated, bare core-shell, or coated core-shell, and comprise at least one material, which has Verdet coefficient equal to or greater than 0.2 degree/mT·μm. In another embodiment, the nanoparticles comprise at least one coating layer.

The present invention further relates to a process of forming a composite material comprising coating a plurality of magneto-optic nanoparticles with at least one halogenated outer layer, and dispersing the plurality of coated nanoparticles into a host matrix material.

The present invention even further relates to a process, comprising dispersing a plurality of nanoparticles in a polymer host, wherein the plurality of nanoparticles comprise at least one magneto-optic material.

The present invention even further relates to thin-film magneto-optic articles, and optical components, such as integrated optical components, as well as optical devices, such as optical rotators, such as Faraday rotators, optical isolators, optical circulators, optical modulators, waveguides, and amplifiers, comprising the composite material according to the present invention.

### BRIEF DESCRIPTION OF THE DRAWINGS

The accompanying drawings, which are incorporated in and constitute a part of this specification, illustrate exemplary embodiments of the invention and, together with the written description, serve to explain the principles of the invention.

In the drawings:

FIG. 1 depicts a schematic representation of an exemplary composite material according to one embodiment of the present invention.

FIG. 2 depicts a schematic cross-sectional view of a waveguide according to an embodiment of the present invention

FIG. 3 depicts a schematic representation of waveguides according to one embodiment of the present invention.

FIG. 4 depicts a schematic representation of an optical magneto-optic device according to an embodiment of the present invention.

FIG. 5 depicts schematic representation of a composite material comprising nanoparticles according to another embodiment of the present invention.

FIG. 6 depicts a schematic representation of nanoparticles according to an embodiment of the present invention.

FIG. 7 depicts a flowchart representing a process for forming a composite material according to one embodiment of the present invention.

FIG. 8 depicts an Atomic Force Microscope (AFM) image of nanoparticles.

FIG. 9 depicts the optical loss as a function of the nanoparticles size at two different wavelengths.

FIG. 10 depicts the optical loss as a function of the nanoparticles size at two different wavelengths.

FIG. 11 depicts the optical loss as a function of the nanoparticles sizes at two different wavelengths.

FIG. 12 depicts the scattering loss with pore diameter for a fluoropolymer with different fractions of residual porosity.

FIG. 13 depicts optical components comprising the magneto-optic polymer nanocomposite according to one embodiment of the present invention.

FIG. 14 depicts polarization rotation of a linearly polarized light beam by a magneto-optic polymer nanocomposite optical article according to one embodiment of the present invention.

FIG. 15 depicts polarization rotation of a linearly polarized light beam by a magneto-optic polymer nanocomposite optical article according to another embodiment of the present invention.

FIG. 16. depicts the schematic representation of relative position of a magneto-optic polymer nanocomposite and magnets in an optical article according to the present invention.

### DETAILED DESCRIPTION OF THE INVENTION

In the following description, reference is made to the accompanying drawings that form a part thereof, and in which is shown by way of illustration specific exemplary embodiments in which the invention can be practiced. These embodiments are described in sufficient detail to enable those skilled in the art to practice the invention, and it is to be understood that other embodiments can be utilized and that changes can be made without departing from the scope of the present invention.

For the purpose of this disclosure the distribution of nanoparticles in a matrix is termed a composite material. Composite materials comprising nanoparticles distributed within a polymer matrix material may offer desirable properties. They may for example, improve the thermal stability, chemical resistance, biocompatibility of components and materials comprising them. In one embodiment, the small size of the nanoparticles may impart the composite material with properties derived from the nanoparticles without significantly affecting other properties of the matrix material. For example, nanoparticles may be smaller than the wavelength of incident light, such that incident light does not interact with the nanoparticles. In other words, the incident light does not scatter from interactions with the nanoparticles. Therefore, when appropriately sized nanoparticles are distributed within a transparent host matrix, the host matrix material may remain optically transparent because scattering of the light incident upon the nanoparticles within the host matrix material is insignificant or absent.

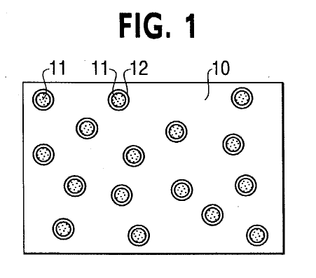

FIG. 1 provides a diagrammatic representation of a composite material according to an embodiment of the invention. In one embodiment, the composite material includes random glassy polymer host matrix 10 and plurality of nanoparticles 11 dispersed either uniformly or non-uniformly within the host matrix 10. Suitable host matrix may comprise an amorphous organic polymer. Organic polymers may include typical hydrocarbon polymers and halogenated polymers. It is generally desirable that in an optical component, such as an optical film, or a bulk optical component, e.g., an optical lens, filter, prism, plate, or canopy enclosure, the total optical loss, consisting of both absorption and the scattering loss, be kept at a minimum.

Among the various mechanisms of optical scattering loss, an important factor is the porosity of the optical material. As a result of the interplay between various material characteristics, e.g., surface energy, solubility, glass transition temperature, entropy, etc., and processing conditions, e.g., temperature, pressure, atmosphere, etc., optical materials, such as amorphous perfluoropolymers can exhibit a large amount of nanoporous structures under normal processing conditions. Such nanoporous structures can cause optical scattering loss and should be eliminated, or converted to smaller sizes, in order to satisfy a certain low optical loss device performance requirement. By controlling the pore sizes and pore structures, optical scattering losses can be greatly reduced. For discrete nanopores that are approximately spherical in shape and are evenly distributed into a host matrix, the scattering loss α, in dB per unit length, resulting from the presence of the nanopores, is dependent on the pore diameter d, the refractive index ratio of the pores and the surrounding host material m=nₚₒᵣ/nₛᵤᵣ, and the volume fraction of the nanopores in the host Vₚ. The nanopore induced scattering loss can be calculated by:

$$α = 1.692 \times {10}^{3} {( \frac{{m}^{2} - 1}{{m}^{2} + 2} )}^{2} \frac{{d}^{3} {V}_{p}}{{λ}^{4}} \qquad ( 1 )$$

wherein λ is the vacuum propagation wavelength of the light inside the composite mateiral. As an example, when m=1.3, Vₚ=10%, λ=1550 nm, d=10 nm, the calculated scattering loss α is 0.001 dB/cm. To fabricate a certain optical component with a set loss specification, and therefore a nanopore induced scattering loss budget of α, the nanopore diameter d should satisfy the following relationship:

$$d < {( α \frac{1}{1.692 \times {10}^{3}} {( \frac{{m}^{2} + 2}{{m}^{2} - 1} )}^{2} \frac{{λ}^{4}}{{V}_{p}} )}^{1 / 3} \qquad ( 2 )$$

wherein λ is the vacuum propagation wavelength of the light inside the composite, m=nₚₒᵣ/nₛᵤᵣ the refractive index ratio of the nanopores and the host material, and Vₚ the volume fraction of the nanopores in the host material. For example, following Equation 2, with a nanopore loss budget of α=0.5 dB/cm, when m=1.3, Vₚ=10%, λ=1550 nm, the nanopore diameter d must be smaller than 37 nm. In certain embodiments, the diameter of the nanopores should be smaller than 100 nm, and such as smaller than 50 nm.

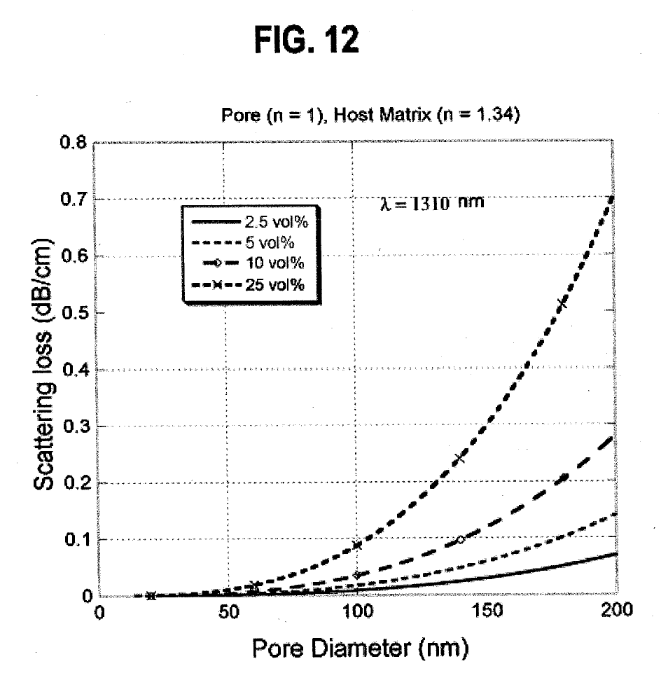

By treating the pores as spherical particles of refractive index equal to 1, the expected scattering loss as function of pore diameter, for wavelength (λ) equals 1310 nm, as shown in FIG. 12. For the case of nanopores in a fluoropolymer film (n=1.34), a residual porosity of 5 vol % with an average diameter of 20 nm, would lead to a scattering loss of 1.4×10⁻⁴ dB/cm at λ=1310 nm. Such residual nanoporosity does not lead to any significant scattering loss. However, for film which was highly porous, with a porosity volume fraction as high as 25%, scattering losses will remain below 7×10⁻⁴ dB/cm as long as the pore diameter does not exceed 20 nm.

Nanoporous materials comprising nanopores distributed within a host matrix material may be used in optical applications. For example, in an optical article, the composite material should exhibit little, or no, optical attenuation, or loss, in signal propagation through the material. A potential source for loss dependent behavior are material scattering centers such as relatively extensive pore or void structures present in the composite material.

Thus, nanopores can be distributed in the host matrix in great numbers as separate individual pores, or as joined clusters, some even extending as a continuous interconnected network-like structure over the entire material sample, thereby forming a nanoporous structure.

Clustering of the nanopores within the host matrix material may result in a porous material that lacks a desired characteristic. Specifically, when nanopores fuse together, the larger nanoporous structures formed may not behave in a similar way to the smaller nanopores. For example, while nanopores may be small enough to avoid scattering light within the matrix material, fused pores may be sufficiently large to cause scattering. As a result, a host matrix material may become substantially less transparent in the presence of such nanoporous structures.

Thus, for example, of many potential host matrix polymer materials, halogenated polymers have been shown to have potential to be used in the optical field. Halogenated polymers, such as fluoropolymers, are well known to be problematic toward pore-like structures. However, in the optical field, the presence of such porous structures, especially on nanometer length scales, in optical articles made of halogenated polymers can ultimately cause light to scatter, especially, for example, in optical thin films, sheets, or bulk articles, thereby resulting in significant optical signal attenuation. To achieve lower optical loss, it is, therefore, important to control the size and distribution of the nanopores and associated nanoporous structures.

In one embodiment, the host matrix 10 may comprise a polymer, a copolymer, a terpolymer, either by itself or in a blend with other matrix material.

In another embodiment, the host matrix 10 can comprise a halogenated elastomer, a perhalogenated elastomer, a halogenated plastic, or a perhalogenated plastic, either by itself or in a blend with other matrix material listed herein.

In yet another embodiment, the host matrix 10 may comprise a polymer, a copolymer, or a terpolymer, having at least one halogenated monomer represented by one of the following formulas:

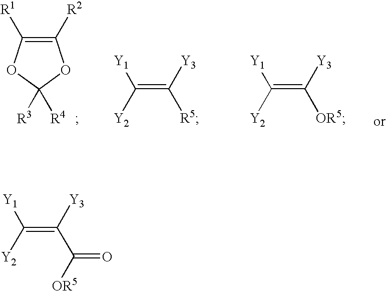

wherein R¹, R², R³, R⁴, and R⁵, which may be identical or different, are each chosen from linear and branched hydrocarbon-based chains, possibly forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane. Y₁ and Y₂, which may be identical or different, are each chosen from H, F, Cl, and Br atoms. Y₃ is chosen from H, F, Cl, and Br atoms, CF₃, and CH₃.

Alternatively, the polymer may comprise a condensation product made from the monomers listed below:

HO—R—OH+NCO—R′—NCO;

or

HO—R—OH+Ary¹-Ary²,

wherein R, R′, which may be identical or different, are each chosen from halogenated alkylene, halogenated siloxane, halogenated ether, halogenated silylene, halogenated arylene, halogenated polyether, and halogenated cyclic alkylene. Ary¹, Ary², which may be identical or different, are each chosen from halogenated aryls and halogenated alkyl aryls.

Ary as used herein, is defined as being a saturated, or unsaturated, halogenated aryl, or a halogenated alkyl aryl group.

Alternatively, the host matrix 10 can comprise a halogenated cyclic olefin polymer, a halogenated cyclic olefin copolymer, a halogenated polycyclic polymer, a halogenated polyimide, a halogenated polyether ether ketone, a halogenated epoxy resin, a halogenated polysulfone, or halogenated polycarbonate.

In certain embodiments, the host matrix 10, for example, a fluorinated polymer host matrix 10, may exhibit very little absorption loss over a wide wavelength range. Therefore, such fluorinated polymer materials may be suitable for optical applications.

In one embodiment, the halogenated aryl, alkyl, alkylene, alkylene ether, alkoxy, siloxane, ether, polyether, thioether, silylene, and silazane groups are at least partially halogenated, meaning that at least one hydrogen in the group has been replaced by a halogen. In another embodiment, at least one hydrogen in the group may be replaced by fluorine. Alternatively, these aryl, alkyl, alkylene, alkylene ether, alkoxy, siloxane, ether, polyether, thioether, silylene, and silazane groups may be completely halogenated, meaning that each hydrogen of the group has been replaced by a halogen. In an embodiment, the aryl, alkyl, alkylene, alkylene ether, alkoxy, siloxane, ether, polyether, thioether, silylene, and silazane groups may be completely fluorinated, meaning that each hydrogen has been replaced by fluorine. Furthermore, the alkyl and alkylene groups may comprise from 1 to 12 carbon atoms.

Additionally, host matrix 10 may comprise a combination of one or more different halogenated polymers, such as fluoropolymers, blended together. Further, host matrix 10 may also include other polymers, such as halogenated polymers containing functional groups such as phosphinates, phosphates, carboxylates, silanes, siloxanes, sulfides, including POOH, POSH, PSSH, OH, SO₃H, SO₃R, SO₄R, COOH, NH₂, NHR, NR₂, CONH₂, NH—NH₂, and others, wherein R may comprise any of aryl, alkyl, alkylene, siloxane, silane, ether, polyether, thioether, silylene, and silazane. Further, host matrix 10 may also include homopolymers or copolymers of vinyl, acrylate, methacrylate, vinyl aromatic, vinyl esters, alpha beta unsaturated acid esters, unsaturated carboxylic acid esters, vinyl chloride, vinylidene chloride, and diene monomers. Further, the host matrix may also include a hydrogen-containing fluoroelastomer, a hydrogen-containing perfluoroelastomer, a hydrogen containing fluoroplastic, a perfluorothermoplastic, at least two different fluoropolymers, or a cross-linked halogenated polymer.

Examples of the host matrix 10 include: poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl)perfluorotetrahydrofuran], poly[2,2,4-trifluoro-5-trifluoromethoxy-1,3-dioxole-co-tetrafluoroethylene], poly(pentafluorostyrene), fluorinated polyimide, fluorinated polymethylmethacrylate, polyfluoroacrylates, polyfluorostyrene, fluorinated polycarbonates, fluorinated poly (N-vinylcarbazole), fluorinated acrylonitrile-styrene copolymer, fluorinated Nafion®, fluorinated poly(phenylenevinylene), perfluoro-polycyclic polymers, polymers of fluorinated cyclic olefins, or copolymers of fluorinated cyclic olefins.

Additionally, the host matrix 10 may comprise any polymer sufficiently clear for optical applications. Examples of such polymers include polymethylmethacrylates, polystyrenes, polycarbonates, polyimides, epoxy resins, cyclic olefin copolymers, cyclic olefin polymers, acrylate polymers, PET, polyphenylene vinylene, polyether ether ketone, poly (N-vinylcarbazole), acrylonitrile-styrene copolymer, or poly(phenylenevinylene).

By including halogens, such as fluorine, into host matrix 10, the optical properties of host matrix 10 and the resulting composite material are improved over conventional composite materials. Unlike the C—H bonds of hydrocarbon polymers, carbon-to-halogen bonds (such as C—F) shift the vibrational overtones toward longer wavelengths out of the ranges used in telecommunication applications. As hydrogen is removed through partial to total halogenation, the absorption of light by, vibrational overtones is reduced. One parameter that quantifies the amount of hydrogen in a polymer is the molecular weight per hydrogen for a particular monomeric unit. For highly halogenated polymers useful in optical applications, this ratio may be 100 or greater. This ratio approaches infinity for perhalogenated materials.

One class of composite materials includes nanoparticles distributed within a host matrix material. Nanoparticles are particles of a material that have a size measured on a nanometer scale. Generally, nanoparticles are larger than a cluster (which might be only a few hundred atoms in some cases), but with a relatively large surface area-to-bulk volume ratio. While most nanoparticles have a size from about 10 nm to about 500 nm, the term nanoparticles can cover particles having sizes that fall outside of this range.

For example, particles having a size as small as about 1 nm and as large as about 1×10³ nm could still be considered nanoparticles. By introducing nanoparticles into optically transparent host matrix, the absorption and scattering losses due to the nanoparticles may add to the optical loss. In order to keep the optical loss to a minimum, in addition to controlling the loss contribution from the host matrix, it is essential to control the absorption and scattering loss from the nanoparticles doped into the host matrix for optical applications.

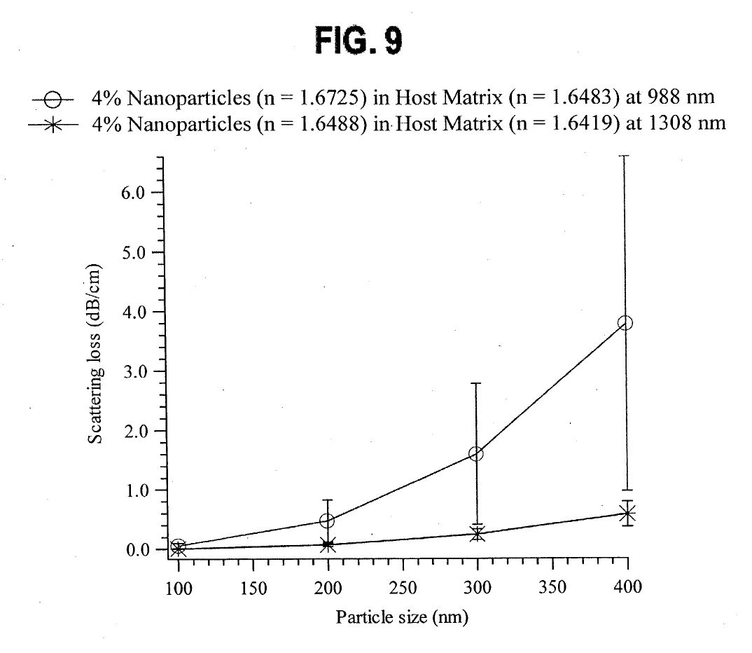

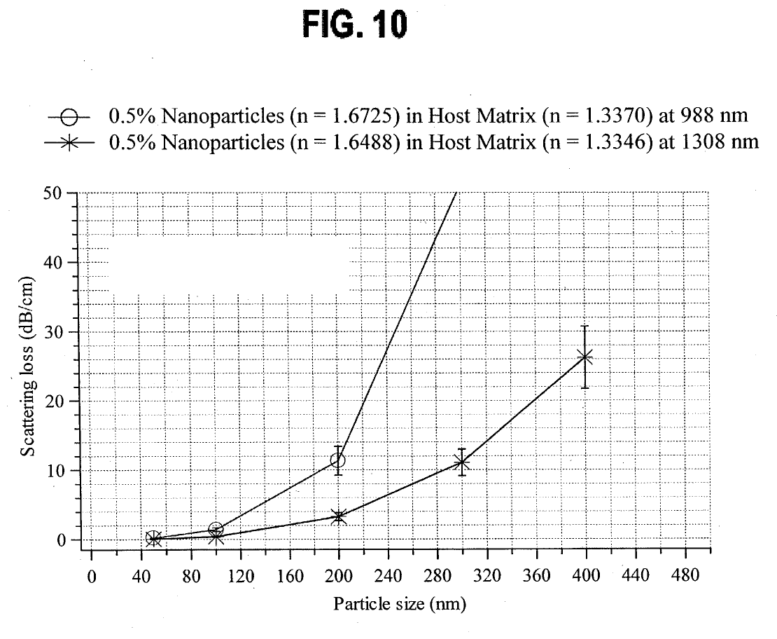

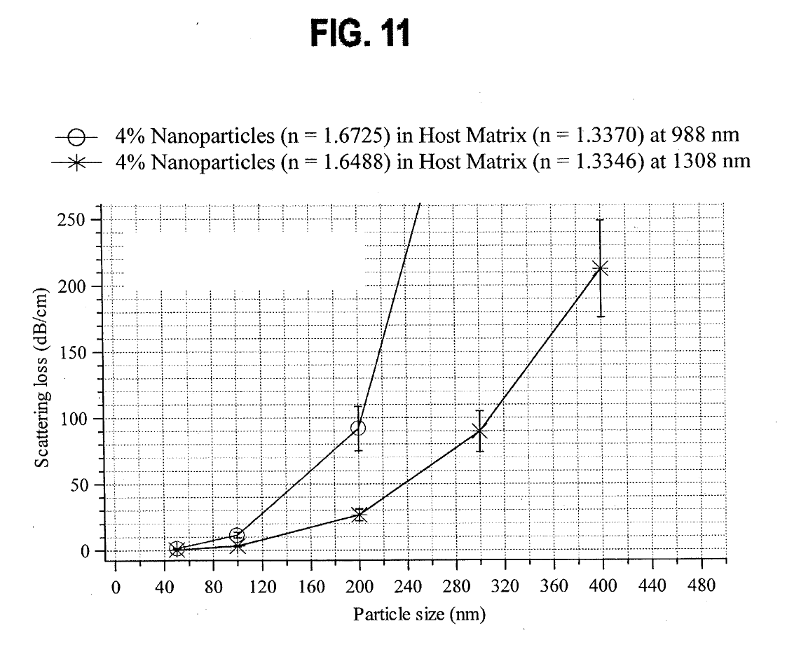

FIGS. 9, 10, and 11 provide examples of scattering loss due to the presence of nanoparticles. Nanocomposite containing nanoparticles with a refractive index of about 1.6725 and a host material with a refractive index of about 1.6483 at 988 nm exhibit a loss of about 0.6 dB/cm. On the other hand, when the index mismatch between the host and the nanoparticles is large, high scattering loss is expected when the particle size exceeds 50 nm as shown in FIGS. 10 and 11. The presence of small nanoparticles with particle diameter less than 20 nm even at high nanoparticles loading (4 vol %) does not lead to any significant scattering loss. Therefore, the nanoparticles size should be kept below 20 nm in order to maintain the low optical loss caused by the presence of nanoparticles.

Nanoparticles can be made from a wide array of materials. Among these materials, examples include metal, glass, ceramics, refractory materials, dielectric materials, carbon and graphite, semiconductors, natural and synthetic polymers including plastics and elastomers, dyes, ion, alloy, compound, composite, and complex of transition metal elements, rare-earth metal elements, group VA elements, semiconductors, alkaline earth metal elements, alkali metal elements, group IIIA elements, and group IVA elements.

Further, the materials may be crystalline, amorphous, or mixtures, or combinations of such structures. Nanoparticles 11 may be bare, coated, bare core-shell, or coated core-shell. Further, nanoparticles themselves may be a nanoparticle matrix, which may comprise a wide array of materials, single elements, mixtures of elements, stoichiometric or non-stoichiometric compounds. The materials may be crystalline, amorphous, or mixtures, or combinations of such structures.

A plurality of nanoparticles 11 may include an outer coating layer 12, which at least partially coats nanoparticles 11 and can inhibit their agglomeration. Suitable coating materials may have a tail group, which is compatible with the host matrix, and a head group, that could attach to the surface of the particles either through physical adsorption or chemical reaction. The nanoparticles 11 according to the present invention may be doped with an effective amount of dopant material. An effective amount is that amount necessary to achieve the desired result. The nanoparticles of doped glassy media, single crystal, or polymer are embedded in the host matrix core material 10. The active nanoparticles may be randomly and uniformly distributed. The nanoparticles of rare-earth doped, or co-doped, glasses, single crystals, organic dyes, or polymers are embedded in the polymer core material. In cases where there is interface delamination due to mismatches of mechanical, chemical, or thermal properties between the nanoparticles and the surrounding polymer core host matrix, a compliance layer may be coated on the nanoparticles to enhance the interface properties between the nanoparticles and the host matrix polymer core material.

As shown in FIG. 1, the nanoparticles may include an outer layer 12. As used herein, the term “layer” is a relatively thin coating on the outer surface of an inner core (or another inner layer) that is sufficient to impart different characteristics to the outer surface. The layer need not be continuous or thick to be an effective layer, although it may be both continuous and thick in certain embodiments.

Nanoparticles 11 may comprise various different materials, and they may be fabricated using several different methods. In one embodiment of the invention, the nanoparticles are produced using an electro-spray process. In this process, very small droplets of a solution including the nanoparticle precursor material emerge from the end of a capillary tube, the end of which is maintained at a high positive or negative potential. The large potential and small radius of curvature at the end of the capillary tube creates a strong electric field causing the emerging liquid to leave the end of the capillary as a mist of fine droplets. A carrier gas captures the fine droplets, which are then passed into an evaporation chamber. In this chamber, the liquid in the droplets evaporates and the droplets rapidly decrease in size. When the liquid is entirely evaporated, an aerosol of nanoparticles is formed. These particles may be collected to form a powder or they may be dispersed into a solution. The size of the nanoparticles is variable and depends on processing parameters.

In an embodiment of the present invention, nanoparticles 11 have a major dimension of less than about 50 nm. That is, the largest dimension of the nanoparticle (for example the diameter in the case of a spherically shaped particle) is less than about 50 nm and in further embodiments about 20 nm.

Other processes are also useful for making the nanoparticles 11 of the present invention. For example, the nanoparticles may be fabricated by laser ablation, laser-driven reactions, flame and plasma processing, solution-phase synthesis, sol-gel processing, spray pyrolysis, flame pyrolysis, laser pyrolysis, flame hydrolysis, mechanochemical processing, sono-electro chemistry, physical vapor deposition, chemical vapor deposition, mix-alloy processing, decomposition-precipitation, liquid phase precipitation, high-energy ball milling, hydrothermal methods, glycothermal methods, vacuum deposition, polymer template processes, micro emulsion processes or any other suitable method for obtaining particles having appropriate dimensions and characteristics. The sol-gel process is based on the sequential hydrolysis and condensation of alkoxides, such as metal alkoxides, intiated by an acidic or a basic aqueous solution in the presence of a cosolvent. Controlling the extent of hydrolysis and condensation reactions with water, surfactants, or coating agents can lead to final products with particle diameters in the nanometer range. The sol-gel process can be used to produce nanoscale metal, ceramic, glass and semiconductor particles. The size of nanoparticles made from varieties of methods can be determined using Transmission Electron Microscope (TEM), Atomic Force Microscope (AFM), or surface area analysis. For crystalline materials, X-ray powder diffraction pattern can also be used to calculate the crystallite size based on line broadening according to a procedure described in Chapter 9 of “X-Ray Diffraction Procedure”, published by Wiley in 1954.

The presence of the nanoparticles can affect other properties of the composite material. For example, for optical applications, the nanoparticle material may be selected according to a particular, desired index of refraction. For certain structural applications, the type of material used to form the nanoparticles 11 may be selected according to its thermal properties, or coefficient of thermal expansion. Still other applications may depend on the mechanical, magnetic and electrical properties of the material used to form nanoparticles 11.

Several classes of materials may be used to form nanoparticles 11 depending upon the effect the nanoparticles are to have on the properties of the composite containing them. In one embodiment, nanoparticles 11 may comprise at least one active material, which can allow the composite to be a magneto-optic media. Active materials can act as magneto-optic media toward a light signal as the light signal encounters the active material. Active materials may include materials having Verdet coefficient equal to or greater than 0.2 degree/mT·μm and may include transition metal elements, rare-earth metal elements, the actinide element uranium, group VA elements, semiconductors, and group IVA elements in the forms of ions, alloys, compounds, composites, complexes, chromophores, dyes or polymers. Examples of such active materials include, but are not limited to, YVO₄, TbPO₄, HoYbBiIG, (Cd,Mn,Hg)Te, MnAs, Y_{2.82}Ce_{0.18}Fe₅O₁₂, Bi-substituted iron garnet, Yttrium Iron Garnet, Terbium Gallium Garnet, and Lithium Niobate. Active materials can also comprise combinations of the above mentioned materials.

The Verdet coefficient can readily be determined by one of ordinary skill in the art using known techniques.

In another embodiment, at least one of the plurality of nanoparticles has a Faraday effect.

The material that forms the matrix of nanoparticle 11 may be in the form of ions, alloys, compounds, composites, complexes, chromophores, dyes or polymers, and may comprise at least one of the following entity: an oxide, phosphate, halophosphate, phosphinate, arsenate, sulfate, borate, aluminate, gallate, silicate, germanate, vanadate, niobate, tantalaite, tungstate, molybdate, alkalihalogenate, halogenide, nitride, selenide, sulfide, sulfoselenide, tetrafluoroborate, hexafluorophosphate, phosphonate, and oxysulfide.

In certain embodiments, the semiconductor materials, for example, Si, Ge, SiGe, GaP, GaAs, GaN, InP, InAs, InSb, PbSe, PbTe, InGaAs, and other stoichiometries as well as compositions, alone, or together, or doped with an appropriate ion may be incorporated in a nanoparticle for magneto-optic media.

Metal comprising materials such as metal chalocogenides, metal salts, transition metals, transition metal complexes, transition metal containing compounds, transition metal oxides, and organic dyes, such as Rodamin-B, DCM, Nile red, DR-19, and DR-1, and polymers may be used. ZnS, or PbS doped with a rare-earth or transition metal for gain media can also be used to form nanoparticles.

Several classes of materials may be used to form nanoparticles 11 depending upon the effect the nanoparticles are to have on the properties of the composite containing them. In one embodiment, nanoparticles 11 may include at least one active material, which can allow the composite to be a novel optical medium. Active materials can change the index of refraction of the composite material. Active materials may include nanoparticles 11 made from metals, semiconductors, dielectric insulators, and various forms and combinations of ions, alloys, compounds, composites, complexes, chromophores, dyes or polymers.

In one embodiment, the metal oxide TiO₂, for example, may be incorporated in a nanoparticle for tuning and control of the index of refraction of the composite material.

In another embodiment, nanopores with index of refraction equal to 1, for example, may be incorporated in a host matrix for tuning and control of the index of refraction of the composite material.

In a further embodiment, the semiconductor materials having the index of refraction values ranging from about 2 to about 5, for example, may be incorporated in a nanoparticle for tuning and control of the index of refraction of the composite material. These materials include, for example, Si, Ge, SiGe, GaP, GaAs, InP, InAs, InSb, ZnS, PbS, PbSe, PbTe, InGaAs, and other stoichiometries as well as compositions, alone, or together, or doped with appropriate ions.

In a further embodiment, the inorganic materials having the index of refraction values ranging from about 1 to about 4, for example, may be incorporated in a nanoparticle for tuning and control of the index of refraction of the composite material. These materials include, for example, TiO₂, SiO₂, B₂O₃, P₂O₅, Ge₂O₃, ZnO₂, LiNbO₃, BaTiO₃, YAlO₃, Proustite, Zirconate, and other related materials as well as their counterparts doped with appropriate ions.

Inclusion of nanoparticles, or nanopores, 11 into host matrix material 10, in certain applications according to the present invention, may provide a composite material useful in optical waveguide applications. For example, nanoparticles 11 provide the capability of fabricating an magneto-optic material having a particular index of refraction. By controlling the index of refraction in this way, transmission losses in optical path resulting from index of refraction mismatches in adjacent materials could be minimized. Additionally, because of the small size of nanoparticles 11, the composite material may retain all of the desirable transmission properties of the host matrix material 10. Using the nanoparticles disclosed herein, the index of refraction can be tuned to from about 1 to about 5.

One method to manufacture an optical device, such as waveguide assemblies, according to the present invention begins by first preparing the substrate. The surface of the substrate is cleaned to remove any adhesive residue that may be present on the surface of the substrate. Typically, a substrate is cast or injection molded, providing a relatively smooth surface on which it can be difficult to deposit a perfluoropolymer, owing to the non-adhesive characteristics of perfluoropolymers in general. After cleaning, the substrate is prepared to provide better adhesion of the lower layer to the surface of the substrate. The substrate can be prepared by roughening the surface or by changing the chemical properties of the surface to better retain the perfluoropolymer comprising the lower layer. One example of the roughening method is to perform reactive ion etching (RIE) using argon. The argon physically deforms the surface of the substrate, generating a desired roughness of approximately 50 to 100 nanometers in depth. One example of the method that can change the chemical properties of the surface of the substrate is to perform RIE using oxygen. The oxygen combines with the polymer comprising the surface of the substrate, causing a chemical reaction on the surface of the substrate and oxygenating the surface of the substrate. The oxygenation of the substrate can allow the molecules of the perfluoropolymer comprising the lower layer to bond with the substrate. Those skilled in the art will recognize that other methods can also be used to prepare the substrate.

The lower layer is then deposited onto the substrate. For a lower layer constructed from poly[2,2,4-trifluoro-5-trifluoromethoxy-1,3-dibxole-co-tetrafluoroethylene], solid poly[2,2,4-trifluoro-5-trifluoromethoxy-1,3-dioxole-co-tetrafluoroethylene] is dissolved in a solvent, perfluoro(2-butyltetrahydrofuran), which is sold under the trademark FC-75, as well as perfluoroalkylamine, which is sold under the trademark FC-40. Other potential solvents are a perfluorinated polyether, such as that sold under the trademark H GALDEN® series HT170, or a hydrofluoropolyether, such as that sold under the trademarks H GALDEN® series ZT180 and ZT130. For a lower layer constructed from other polymers, each polymer is dissolved in a suitable solvent to form a polymer solution. The polymer solution is then spin-coated onto the substrate using known spin-coating techniques. The substrate and the lower layer are then heated to evaporate the solvent from the solution.

In one embodiment, the lower layer is spin-coated as several thinner layers, such that a first thin layer is applied to the substrate, baked to evaporate the solvent, and annealed to densify the polymer, a second thin layer is applied to the first layer and densified, and a third thin layer is applied to the second layer and densified. For example, after all of the layers are applied, the lower layer achieves a height ranging from 8 to 12 micrometers. Although the application of three layers is described, those skilled in the art will recognize that more or less than three layers can be used.

After the lower layer has dried and densified, the polymer core is deposited onto the lower layer, for example, using the same technique as described above to deposit the lower layer onto the substrate. Instead of depositing several sub-layers of the core onto the lower layer, however, only one layer of the core is deposited, for example, deposited onto the lower layer. In one embodiment, the core is soluble in a solvent in which the lower layer is not soluble so that the solvent does not penetrate the lower layer and disturb the lower layer. For a core constructed from poly[2,3-(perfluoroalkenyl)perfluorotetrahydrofuran], solid poly[2,3-(perfluoroalkenyl)perfluorotetrahydrofuran] is dissolved in a solvent, such as perfluorotrialkylamine, which is sold under the trademark CT-SOLV 180™, or any other solvent that readily dissolves polymer, forming a polymer solution. Alternatively, poly[2,3-(perfluoroalkenyl)perfluorotetrahydrofuran] can be commercially obtained already in solution. After the core material is applied and dried, the core film is densified using a low temperature baking process. After the core is dried, a thickness of the core and lower layer is, for example, ranging approximately from 12 to 16 microns.

Next, the upper layer is deposited onto the core, the core layer, and any remaining portion of the lower layer not covered by the core or the core layer. For example, similar to the lower layer, the upper layer is spincoated in layers, such that a first layer is applied to the core and a remaining portion of the lower layer layer not covered by the core, baked to evaporate the solvent, and annealed to densify the polymer, a second layer is applied to the first layer, baked and densified, and a third layer is applied to the second layer, baked, and densified. In one embodiment, the upper layer is soluble in a solvent in which the core and core layer are not soluble so that the solvent does not penetrate the core and the core layer and disturb the core or the core layer. For example, after all of the layers are applied, the entire waveguide achieves a height ranging approximately from 15 to 50 micrometers. Although the application of three layers is described, those skilled in the art will recognize that more or less than three layers can be used. Alternatively, the upper layer can be a different material from the lower layer, but with approximately the same refractive index as the lower layer, for example, a photocuring fluorinated acrylate or a thermoset.

The layers are not necessarily flat, but contour around the core with decreasing curvature for each successive layer. Although the last layer is shown with a generally flat top surface, those skilled in the art will recognize that the top surface of the last layer need not necessarily be flat. Those skilled in the art will also recognize that single layer with high degrees of flatness or planarization can be achieved by either spincoating or casting processes.

After forming the multi-layer structure, the assembly is cut to a desired size and shape, for example, by dicing. A desired shape is generally rectangular, although those skilled in the art will recognize that the assembly can be cut to other shapes as well.

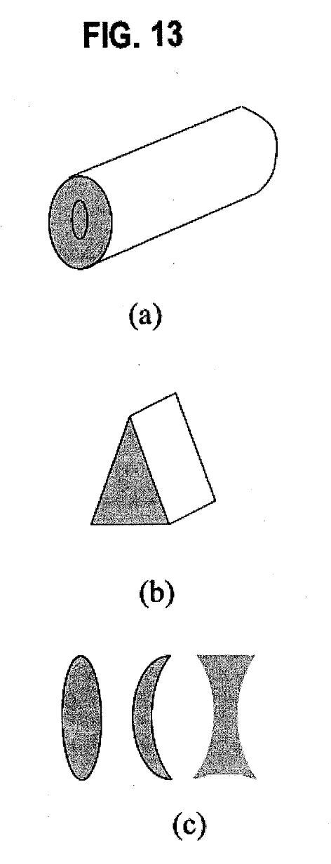

Other examples of optical components that can be made with the disclosed nanoporous materials processing method include, but are not limited to: optical bulk articles, such as prisms, lenses, filters, plates, and canopy enclosures, optical anti-reflection coatings, and optical band-pass thin film filters, as illustrated in the FIGS. 13(a) through 13(c).

Optical thin film magneto-optic coatings can be fabricated from nanoporous materials by extrusion, casting, dipping, spin-coating, etc.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Several classes of materials may be used to form nanoparticles 11 depending upon the effect the nanoparticles are to have on the properties of the composite containing them. In one embodiment, nanoparticles 11 may include at least one active material, which can allow the composite to be a novel electrical medium. Active materials can change the electrical conductivity of the composite material. Active materials may include nanoparticles 11 made from metals, semiconductors, dielectric insulators, and in various inorganic and organic forms and combinations of ions, alloys, compounds, composites, complexes, chromophores, dyes or polymers.

The present invention also discloses a method of making a nanoporous polymer material by controlling the size, shape, volume fraction, and topological features of the pores, which comprises annealing the polymer material at a temperature above its glass transition temperature. The present invention further discloses the use of the resulting nanoporous polymer material to make devices, such as optical devices.

In one embodiment, the metal Ag, for example, may be incorporated in a nanoparticle for tuning and control of the electrical conductivity of the composite material so as to provide wavelength tunability to the magneto-optic material.

In another embodiment, the semiconductor Si, for example, may be incorporated in a nanoparticle for tuning and control of the electrical conductivity of the composite material so as to provide wavelength tunability to the magneto-optic material.

In a further embodiment, the dielectric insulator SiO₂, for example, may be incorporated in a nanoparticle for tuning and control of the electrical conductivity of the composite material so as to provide wavelength tunability to the magneto-optic material.

Several classes of materials may be used to form nanoparticles 11 depending upon the effect the nanoparticles are to have on the properties of the composite containing them. In one embodiment, nanoparticles 11 may include at least one active material, which can allow the composite to be a novel dielectric medium. Active materials can change the dielectric constant of the composite material. Active materials may include nanoparticles 11 made from dielectric insulators, such as NaCl, TiO₂, SiO₂, B₂O₃, Ge₂O₃, ZnO₂, LiNbO₃, and BaTiO₃, and various forms and combinations of ions, alloys, compounds, composites, complexes, chromophores, dyes or polymers, such as PVDF.

Several classes of materials may be used to form nanoparticles 11 depending upon the effect the nanoparticles are to have on the properties of the composite containing them. In one embodiment, nanoparticles 11 may include at least one active material, which can allow the composite to be a novel magnetic material. Active materials can change the magnetic susceptibility of the composite material. Active materials may include nanoparticles 11 made from paramagnetic, ferromagnetic, antiferromagnetic, ferrimagnetic, and diamagnetic materials.

Several classes of materials may be used to form nanoparticles 11 depending upon the effect the nanoparticles are to have on the properties of the composite containing them. In one embodiment, nanoparticles 11 may include at least one active material, which can allow the composite to be a novel mechanical material. Active materials can change the mechanical properties of the composite material. Active materials may include nanoparticles 11 and in various forms and combinations of alloys, compounds, crystals, composites, complexes, chromophores, dyes or polymers.

Several classes of materials may be used to form nanoparticles 11 depending upon the effect the nanoparticles are to have on the properties of the composite containing them. In one embodiment, nanoparticles 11 may include at least one active material, which can allow the composite to be a novel magnetooptic material. Active materials can change the magneto-optic coefficient of the composite material. Active materials may include nanoparticles 11 made from magneto-optic materials, such as YVO₄, TbPO₄, HoYbBiIG, (Cd,Mn,Hg)Te, MnAs, Y_{2.82} Ce_{0.18}Fe₅O₁₂, Bi-substituted iron garnet, Yttrium Iron Garnet, Terbium Gallium Garnet, Lithium Niobate, and paramagnetic rare-earth ions, such as Tb⁺³, Y⁺³, and Ce⁺³.

In one embodiment, the nanoparticles are coated with a polymer, such as a halogenated polymer. In certain embodiments, the coated nanoparticles comprise at least one active material.

Because many semiconductor materials have refractive index values ranging from about 2 to about 5, these materials can be used to tune the refractive index of the nanocomposite materials for optical applications, such as magneto-optic media. Thus, semiconductor materials may also be used to form nanoparticles 11. These materials include, for example, Si, Ge, SiGe, GaP, GaAs, InP, InAs, InSb, ZnS, PbS, PbSe, PbTe, and other semiconductor materials, as well as their counterparts doped with a rare-earth or transition metal ions. Still other materials such as inorganic salts, oxides or compounds can be used to tune the refractive index of the nanocomposite materials for optical applications, such as magneto-optic media. For example lithium niobate, barium titinate, proustite, yttrium aluminate, rutile, and ziroconate and other related materials, as well as their counterparts doped with a rare-earth or transition metal ions.

Still other classes of materials may be used to form nanoparticles 11 depending upon the effect the nanoparticles are to have on the properties of the nanocomposite containing them.

In one embodiment, the nanoparticles are coated with a long chain alkyl group, long chain ether group, or polymer, such as a halogenated long chain alkyl group, halogenated long chain ether group, or halogenated polymer.

In optical waveguide applications, the major dimension of the nanoparticles described herein is smaller than the wavelength of light used. Therefore, light impinging upon nanoparticles 11 will not interact with, or scatter from, the nanoparticles. As a result, the presence of nanoparticles 11 dispersed within the host matrix material 10 has little or no effect on light transmitted through the host matrix. Even in the presence of nanoparticles 11, the low absorption loss of host matrix 10 may be maintained.

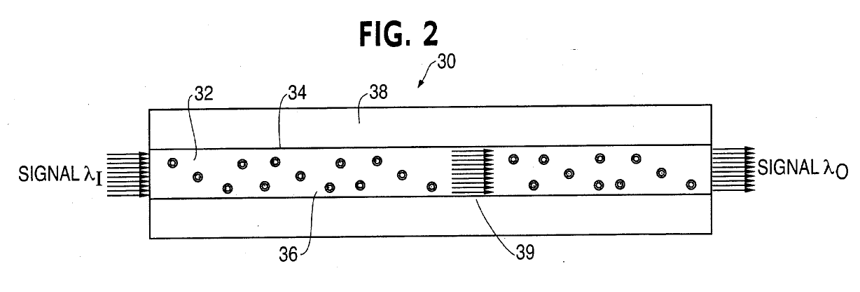

FIG. 2 shows a schematic cross-sectional view of a planar optical waveguide 30 formed using the nanoparticles according to the present invention. A cladding 38 surrounds a core 32 comprised of a host matrix 34 containing the coated nanoparticles 36. In one embodiment, the cladding 38 has a lower index of refraction than core 32. In this embodiment, the nanoparticles added to core 32 increase the index of refraction of the material comprising core 32.

In such an embodiment, input light λ_{I} is injected into the waveguide 30 at one end. The input light λ_{I} is confined within the core 32 as it propagates through core 32. The small size of the nanoparticles allows the input light λ_{I} to propagate without being scattered, which would contribute to optical power loss. Input light λ_{I} interacting with the nanoparticles 36, thus, amplifying the light signal shown schematically at 39.

In another embodiment, the present invention discloses a magneto-optic device, such as an optical isolator, circulator, or modulator.

In one embodiment, the nanoparticles in the magneto-optic media comprise at least one material chosen from YVO₄, TbPO₄, HoYbBiIG, (Cd,Mn,Hg)Te, MnAs, Y_{2.82}Ce_{0.18}Fe₅O₁₂, Bi-substituted iron garnet, Yttrium Iron Garnet, Terbium Gallium Garnet, and Lithium Niobate. In another embodiment, the nanoparticles in the magneto-optic media may comprise at least one active material. The index of refraction of the magneto-optic media and/or adjacent material layers may be adjusted to a desired value with the inclusion of nanoparticles.

Generally, the index of refraction of a composite that includes nanoparticles of appropriate compositions can be adjusted to different selected values. For example, adding nanoparticles disclosed herein to the host matrix can tune the refractive index of the composite to be from 1 to about 5. As a result, the nanocomposite material is suitable for use in various optical applications such as waveguides according to the present invention. The index of refraction for the nanoparticles may be determined using techniques known to one of ordinary skill in the art. For example, one can use a refractometer, elipsometer, or index matching fluid to determine the refractive index of the particles either as a film or as powders. For the measurement of nanoparticles powder samples, one can use the index matching fluid to determine the refractive index of the material. Typically, a drop of index matching fluid or immersion oil is placed onto a glass slide. A small amount of powder sample can then be mixed into the fluid droplet. The slide can then be viewed using a transmission optical microscope. The microscope is equipped with a sodium D line filter to ensure that the refractive index is being measured at a wavelength of 588 nm. The boundary between the index matching fluid and the powder can be seen when the index of the fluid and the sample is not matched. The same procedure should be repeated, using immersion oils with successively higher indices of refraction, until the boundary line can no longer be seen. At this point, the index of the immersion oil matches that of the powder.

In one embodiment, there is a halogenated polymer host matrix having a refractive index, ηₘₐₜᵣᵢₓ and a plurality of nanoparticles dispersed within the halogenated polymer host matrix having a refractive index η_{particle}. In this embodiment, the halogenated polymer host matrix and the plurality of nanoparticles form a composite having a refractive index, η_{comp}, wherein ηₘₐₜᵣᵢₓ is not equal to η_{particle}. Further, the nanoparticles within the halogenated polymer host matrix are in such an amount sufficient to result in a value for η_{comp} which is different from ηₘₐₜᵣᵢₓ.

In another embodiment, a nanocomposite material can be fabricated that has a high index of refraction and low absorption loss, for example, less than approximately 2.5×10⁻⁴ dB/cm in the range from about 1.2 μm to about 1.7 μm. As previously stated, halogenated polymers, including fluorinated polymers, can exhibit very little absorption loss (see Table 1).

TABLE 1
WAVELENGTHS AND INTENSITIES OF
SOME IMPORTANT VIBRATIONAL OVERTONES

| Bond | n | Wavelength (nm) | Intensity (relative) |
|---|---|---|---|
| C—H | 1 | 3390 | 1 |
| C—H | 2 | 1729 | 7.2 × 10⁻² |
| C—H | 3 | 1176 | 6.8 × 10⁻³ |
| C—F | 5 | 1626 | 6.4 × 10⁻⁶ |
| C—F | 6 | 1361 | 1.9 × 10⁻⁷ |
| C—F | 7 | 1171 | 6.4 × 10⁻⁹ |
| C═O | 3 | 1836 | 1.2 × 10⁻² |
| C═O | 4 | 1382 | 4.3 × 10⁻⁴ |
| C═O | 5 | 1113 | 1.8 × 10⁻⁵ |
| O—H | 2 | 1438 | 7.2 × 10⁻² |

Therefore, these halogenated polymers may be, for example, suitable for transmitting light in optical waveguides and other applications according to the present invention. In such applications, nanoparticles 11 are smaller than the wavelength of incident light. Therefore, light impinging upon nanoparticles 11 will not interact with, or scatter from, the nanoparticles. As a result, the presence of nanoparticles 11 dispersed within the host matrix material 10 has little or no effect on the optical clarity of the composite, even if the nanoparticles themselves comprise material, which in bulk form would not be optically clear, or even translucent. Thus, even in the presence of nanoparticles 11, the low absorption loss of host matrix 10 may be maintained.

By contrast, the presence of nanoparticles 11 within the host matrix material 10 may contribute to significantly different properties as compared to the host matrix material alone. For example, as already noted, nanoparticles 11 may be made from various semiconductor materials, which may have index of refraction values ranging from about 1 to about 5. Upon dispersion of nanoparticles 11 into the host matrix material 10, the resulting composite material will have an index of refraction value somewhere between the index of refraction of the host matrix material 10 (usually less than about 2) and the index of refraction of the nanoparticle material. The resulting, overall index of refraction of the composite material will depend on the concentration and make-up of nanoparticles 11 within the host matrix material 10. For example, as the concentration of nanoparticles 11 in the host matrix material 10 increases, the overall index of refraction may shift closer to the index of refraction of the nanoparticles 11. The value of n_{comp} can differ from the value of nₘₐₜᵣᵢₓ by a range of about 0.2% to about 330%. In an embodiment, the ratio of n_{particle}:nₘₐₜᵣᵢₓ is at least 3:2. In another embodiment, the ratio of n_{particle}:nₘₐₜᵣᵢₓ is at least 2:1.

The nanoparticle containing composites as described herein, may be employed, for example, in various applications including, but not limited to, optical devices, windowpanes, mirrors, mirror panels, optical lenses, optical lens arrays, optical displays, liquid crystal displays, cathode ray tubes, optical filters, optical components, all these more generally referred to as components.

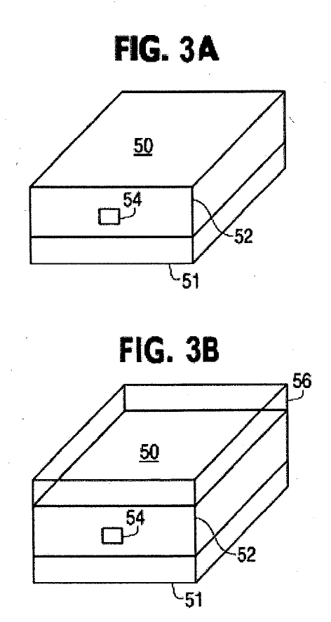

FIG. 3A schematically illustrates an optical waveguide 50 according to one embodiment of the present invention. Optical waveguide 50 includes a generally planar substrate 51, a core material 54 for transmitting incident light and a layer material 52 disposed on the substrate 51, which surrounds the core 54 and promotes total internal reflection of the incident light within the core material 54. The core 54 of the optical waveguide may be formed of a nanocomposite as illustrated, for example, in FIG. 1.

The layer 51 and 52 may be each independently composed of an optical polymer, such as a perfluorinated polymer. The waveguide core 54 may be composed of a nanocomposite material, for example, doped glass, single crystal, or polymer particles with dimensions ranging from about 1 nm to about 100 nm are embedded in a polymer waveguide core.

In such an embodiment, the core 54 may include a host matrix and a plurality of nanoparticles dispersed within the host matrix. A majority of the plurality of nanoparticles present in core 54 may further include a halogenated outer coating layer. The layer material in certain embodiments may comprise a halogenated polymer host matrix. In certain embodiments, the layer material may further include nanoparticles dispersed in a host matrix in such a way that the relative properties of the core and layer can be adjusted to predetermined values.

Further, in one embodiment of the present invention, the host matrix material of the core 54 and/or layer 52 includes fluorine. The nanoparticles in the optical waveguide 50 may have an index of refraction of ranging from about 1 to about 5. By selecting a particular material having a particular index of refraction value, the index of refraction of the core 54 and/or layer layer 52 of the optical waveguide 50 may be adjusted to a predetermined desired value or to different predetermined values.

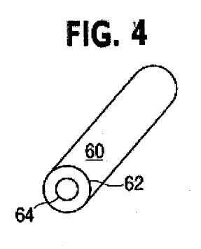

FIG. 4 illustrates an optical magneto-optic device 60 according to another embodiment of the present invention. Optical magneto-optic device 60 comprises an optical fiber with a core 64 surrounded by a layer 62. The core includes a host matrix and a plurality of nanoparticles dispersed within the host matrix. In one embodiment, core 64 comprises nanoparticles. The layer material in this embodiment comprises a host matrix. In certain embodiments, the layer material may also comprise nanoparticles dispersed in a host matrix. Further, in one embodiment of the present invention, the host matrix material of the core 64 and/or layer 62 includes fluorine. The plurality of nanoparticles in the optical magneto-optic device 60 may have an index of refraction ranging from about 1 to about 5. By selecting a particular material having a particular index of refraction value, the overall index of refraction of the core 64 of the optical magneto-optic device 60 may be adjusted to a predetermined desired value or to different predetermined values.

In addition to the materials mentioned, still other materials are useful as nanoparticles 11. For example, the nanoparticles themselves may comprise a polymer. In an embodiment of the invention, the polymer nanoparticles comprise polymers that comprise functional groups that can bind ions, such as rare-earth ions. Such polymers include homopolymers or copolymers of vinyl, acrylic, vinyl aromatic, vinyl esters, alpha beta unsaturated acid esters, unsaturated carboxylic acid esters, vinyl chloride, vinylidene chloride, and diene monomers. The reactive groups of these polymers may comprise at least one of the following: POOH, POSH, PSSH, OH, SO₃H, SO₃R, SO₄R, COOH, NH₂, NHR, NR₂, CONH₂, NH—NH₂, and others, wherein R may be chosen from linear and branched hydrocarbon-based chains, possibly forming at least one carbon-based ring, being saturated and unsaturated, aryl, alkyl, alkylene, siloxane, silane, ether, polyether, thioeter, silylene, and silazane.

The polymers for use as nanoparticles may alternatively comprise main chain polymers comprising magnetic ions in the polymer backbone, or side chain or cross-linked polymers containing the above-mentioned functional groups. The polymers may be highly halogenated yet immiscible with the host matrix polymer. For example, nanoparticles of inorganic polymer, prepared by reacting erbium chloride with perfluorodioctylphosphinic acid, can exhibit high crystallinity and be immscible with poly[2,3-(perfluoroalkenyl)perfluorotetrahydrofuran]. Blending these nanoparticles with the fluorinated polymer host will lead to a nanocomposite. Additionally, the nanoparticles may comprise organic dye molecules, ionic forms of these dye molecules, or polymers containing these dye molecules in the main chain or side chain, or cross-linked polymers. When the nanoparticles comprise polymers that are not halogenated, they may be optionally coated with a halogenated coating as described herein.

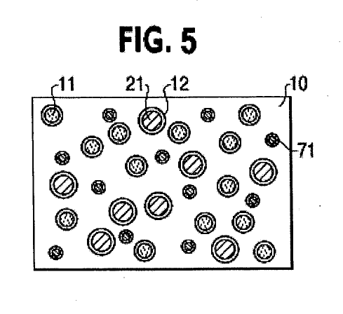

Composite materials comprising magneto-optic media of the present invention may contain different types of nanoparticles. For example, FIG. 5 illustrates an embodiment of the present invention in which several groups of nanoparticles 11, 21, and 71 are present within halogenated matrix 10. Each group of nanoparticles 11, 21, and 71 is comprised of a different material surrounded by an outer layer (for example, layer 12 on particle 21).

Nanocomposites fabricated from several different nanoparticles may offer properties derived from the different nanoparticles. For example, nanoparticles 11, 21, and 71 may provide a range of different optical, structural, or other properties. One skilled in the art will recognize that the present invention is not limited to a particular number of different types of nanoparticles dispersed within the host matrix material. Rather, any number of different types of nanoparticles may be useful in various applications. Depending on the end use, the nanoparticles according to the present invention may be bare, or contain at least one outer layer. As shown in FIG. 1, the nanoparticles may include an outer layer 12. The layer 12 may serve several important functions. It may be used to protect nanoparticle 11 from moisture or other potentially detrimental substances. Additionally, layer 12 may also prevent agglomeration. Agglomeration is a problem when making composite materials that include nanoparticles distributed within a matrix material.

In one embodiment, by selecting a layer 12 of a material that is compatible with a given host matrix material, layer 12 may eliminate the interfacial energy between the nanoparticle surfaces and host matrix 10. As a result, the nanoparticles in the composite material do not tend to agglomerate to minimize the interfacial surface area/surface energy that would exist between uncoated nanoparticles and host matrix material 10. Layer 12, therefore, enables dispersion of nanoparticles 11 into host matrix material 10 without agglomeration of the nanoparticles.

When the outer layer 12 is halogenated, it may comprise at least one halogen chosen from fluorine, chlorine, and bromine. In an embodiment of the present invention, the halogenated outer layer 12 may include, for example, halogenated polyphosphates, halogenated phosphates, halogenated phosphinates, halogenated thiophosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated disulfide, halogenated thiols, and halogenated alkylcyanide. While fluorine analogs of these materials can be used, analogs of these materials incorporating halogens other than fluorine, as well as hydrogen, may also be employed in outer layer 12.

In addition to protecting the nanoparticles 11 and suppressing agglomeration, layer 12 may also be designed to interact with the surfaces of nanoparticles 11. For example, halogenated outer layer 12 may comprise a material, such as one of the above listed, which reacts with and neutralizes an undesirable radical group, for example OH or esters, that may be found on the surfaces of nanoparticles 11. In this way, layer 12 may prevent the undesirable radical from reacting with host matrix 10.

Coatings on nanoparticles 11 are not limited to a single layer, such as halogenated outer coating layer 12 shown in FIG. 1. Nanoparticles may be coated with a plurality of layers.

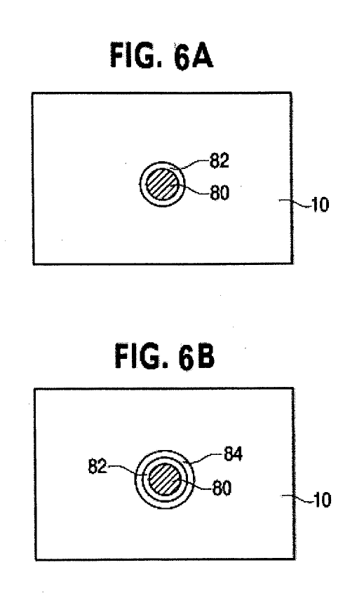

FIG. 6 schematically depicts one nanoparticle suspended within host matrix material 10. As shown in FIG. 6B, inner layer 84 is disposed between nanoparticle 80 and halogenated outer layer 82. In certain situations the interaction between a particular nanoparticle material 80 and a particular halogenated outer layer 84 may be unknown. In these situations, nanoparticles 80 may be coated with an inner coating layer 84 comprising a material that interacts with one or both of the nanoparticle material and the halogenated outer coating layer material in a known way to create a passivation layer. Such an inner coating layer may prevent, for example, delamination of the halogenated outer coating layer 82 from nanoparticle 80. While inner coating layer 84 is shown in FIG. 6B as a single layer, inner coating layer 84 may include multiple layers of similar or different materials.

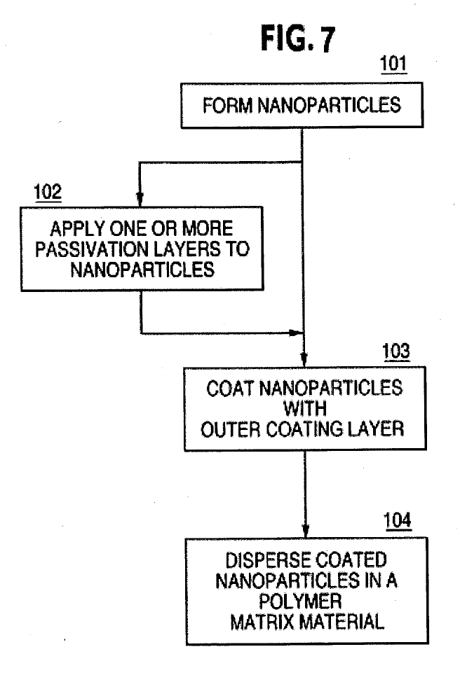

FIG. 7 is a flowchart diagram representing process steps for forming a composite material according to an embodiment of the present invention. Nanoparticles 11, as shown in FIG. 1, are formed at step 101. Once formed, nanoparticles 11 are coated with a outer coating layer 12 at step 103. Optionally, at step 102, an inner coating layer 84 (or passivation layer), as shown in FIG. 6B, may be formed on the nanoparticles 80. Inner coating layer 84, which may include one or more passivation layers, may be formed prior to formation of outer coating layer 82 using methods similar to those for forming outer coating layer 82.

Nanoparticles may be coated in several ways. For example, nanoparticles may be coated in situ, or, in other words, during the formation process. The nanoparticles may be formed (for example, by electro-spray) in the presence of a coating material. In this way, once nanoparticles 11 have dried to form an aerosol, they may already include layer 12 of the desired host material.

In one embodiment, layer 12 may be formed by placing the nanoparticles into direct contact with the coating material. For example, nanoparticles may be dispersed into a solution including a halogenated coating material. In some embodiments, nanoparticles may include a residual coating left over from the formation process. In these instances, nanoparticles may be placed into a solvent including constituents for forming the outer coating layer. Once in the solvent, a chemical replacement reaction may be performed to substitute outer coating layer 12 for the preexisting coating on the plurality of nanoparticles 11. In one embodiment, nanoparticles may be coated with a coating in a gas phase reaction, for example, in a gas phase reaction of hexamethyldisilazane.

In another embodiment, the nanoparticles may be dispersed by co-dissolving them, and the host matrix, in a solvent (forming a solution), spin coating the solution onto a substrate, and evaporating the solvent from the solution.

In another embodiment, the nanoparticles may be dispersed in a monomer matrix, which is polymerized after the dispersion. For example, metal oxide nanoparticles can be dispersed into a liquid monomer under sonication. The resulting mixture is then degassed and mixed with either a thermal initiator or a photo-initiator, such as azo, peracid, peroxide, or redox type initiators. The mixture is then heated to induce polymerization forming a polymer nanocomposite. Additionally, the pre-polymerized mixture can be spin-coated onto a substrate followed by thermally or photo-induced polymerization to form a nanocomposite thin film.

In yet another embodiment, coatings may be in the form of a halogenated monomer. Once the monomers are absorbed on the surface of the particles, they can be polymerized or cross-linked. Additionally, coatings in the form of polymers can be made by subjecting the particles, under plasma, in the presence of halogenated monomers, to form coated nanoparticles with plasma induced polymerization of the particle surface. The coating techniques described are not intended to be an exhaustive list. Indeed, other coating techniques known to one of ordinary skill in the art may be used.

Once nanoparticles have been formed and optionally coated, they are dispersed into host matrix at step 104 to obtain a uniform distribution of nanoparticles within host matrix, a high shear mixer, or a sonicator may be used. Such high shear mixers may include, for example, a homogenizer or a jet mixer.

Another method of dispersing nanoparticles throughout the host matrix is to co-dissolve the nanoparticles with a polymer in a suitable solvent, spin-coating the solution onto a substrate, and then evaporating the solvent to form a polymer nanocomposite film.

Yet another method of dispersing nanoparticles throughout the host matrix is to disperse nanoparticles into a monomer, and then polymerize the monomer to form a nanocomposite. The monomer can be chosen from acrylate, methacrylate, styrene, vinyl carbozole, halogenated methacrylate, halogenated acrylate, halogenated styrene, halogenated substituted styrene, trifluorovinyl ether monomer, epoxy monomer with a cross-linking agent, and anhydride/diamine, although those skilled in the art will recognize that other monomers can be used as well. The dispersion techniques described are not intended to be an exhaustive list. Indeed, other dispersion techniques known to one of ordinary skill in the art can be used.

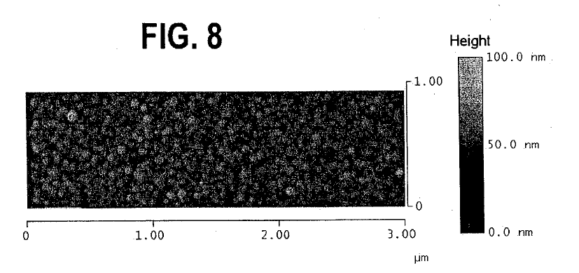

In one embodiment of the present invention, the host matrix may comprise various types of nanoparticles. For example, in certain embodiments the host matrix may comprise particles and/or nanoparticles having positive and/or negative CTE. In other embodiment, the index of refraction of the host matrix can be adjusted by including a single type, or various types, of nanoparticles where the nanoparticles have an index of refraction. The host matrix may also comprise nanoparticles comprising at least one active material. In addition, in certain embodiments, the host matrix may comprise nanoparticles comprising sulfides. Embodiments of the present invention also include matrices comprising particles and/or nanoparticles comprising positive and/or negative CTE, and/or various nanoparticles comprising various indexes of refraction, and/or active materials, and/or sulfides. In certain embodiments, the nanoparticles comprise coatings; while in other embodiments, the nanoparticles have no coating. FIG. 8 shows the AFM image of exemplary nanoparticles with particle size of less then 50 nm. In addition, in certain embodiments, the matrices may be halogenated or non-halogenated. Thus, different combinations are explicitly considered.

In another embodiment, the polymer nanocomposites comprising a host matrix and nanoparticles of various functionalities may further offer improvement in abrasion resistance properties. When fluoropolymers are doped with hard, inorganic materials such as SiO₂, TiO₂, YAG, etc, the polymer abrasion properties can be enhanced by the presence of the inorganic components. These types of polymer composites can offer at least one of additional advantages such as thermal and chemical stability, improved weatherability, and low water absorption when compared with conventional hydrocarbon based composites. For a typical hydrocarbon polymer matrix, such as poly(methyl methacrylate), the water absorption is 0.3% for 60° C. water immersion test. On the other hand, a perfluorinated polymer under the same test condition has less then 0.01% water absorption.

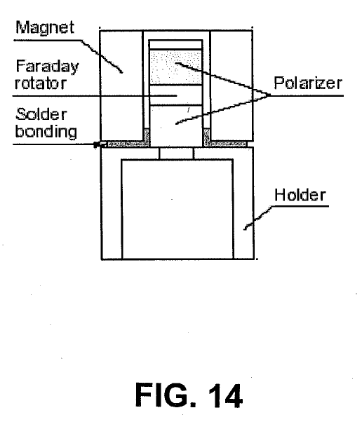

FIGS. 14, 15, and 16 illustrate polarization rotation of a linearly polarized light beam by the magneto-optic polymer nanocomposite optical article according to embodiments of the present invention. In FIG. 14, the optical articlecomprises an input polarizer, a crossed output polarizer, positioned before and after, respectively, a polymer nanocomposite Faraday rotator.

In a Faraday rotator, linearly polarized light is rotated by forty-five degrees either in a clockwise or counterclockwise direction. The typical Faraday rotator requires an applied magnetic field, whereas a latched one does not. The angle of rotation φ of the plane of polarization in a homogeneous medium is expressed by

φ=V B L

wherein V is the Verdet coefficient, B the applied magnetic field in the direction of the light propagation, and L the length over which the magnetic field is applied. The Verdet coefficient depends on wavelength λ change of the index of refraction n of the material and charge e to mass m ratio of the electron

V=(e/2mc)λ(dn/dλ)

wherein c is the velocity of light.

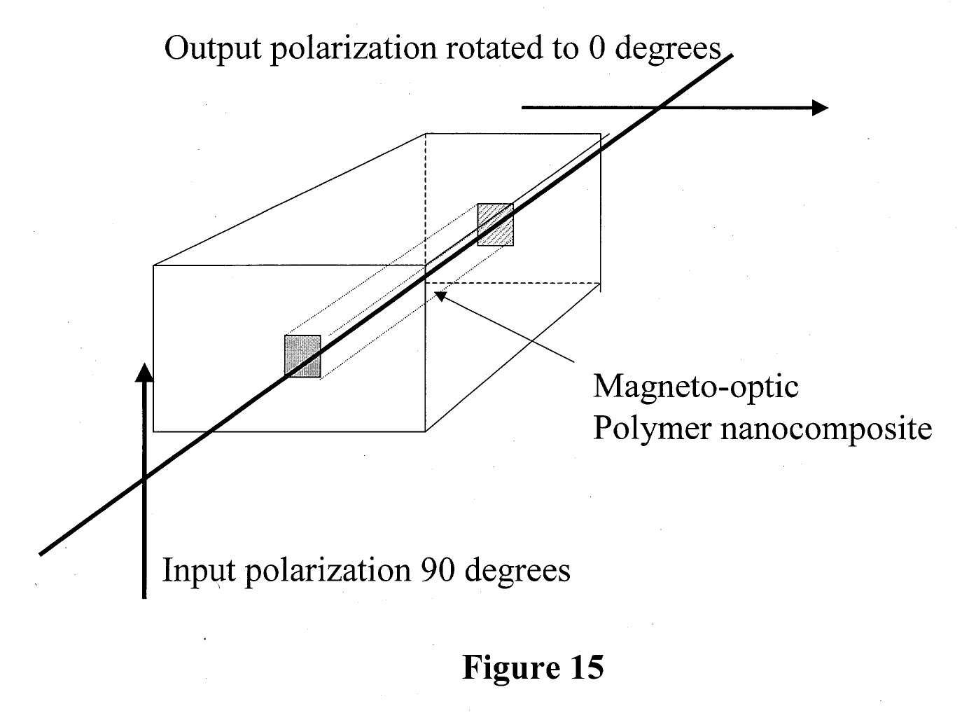

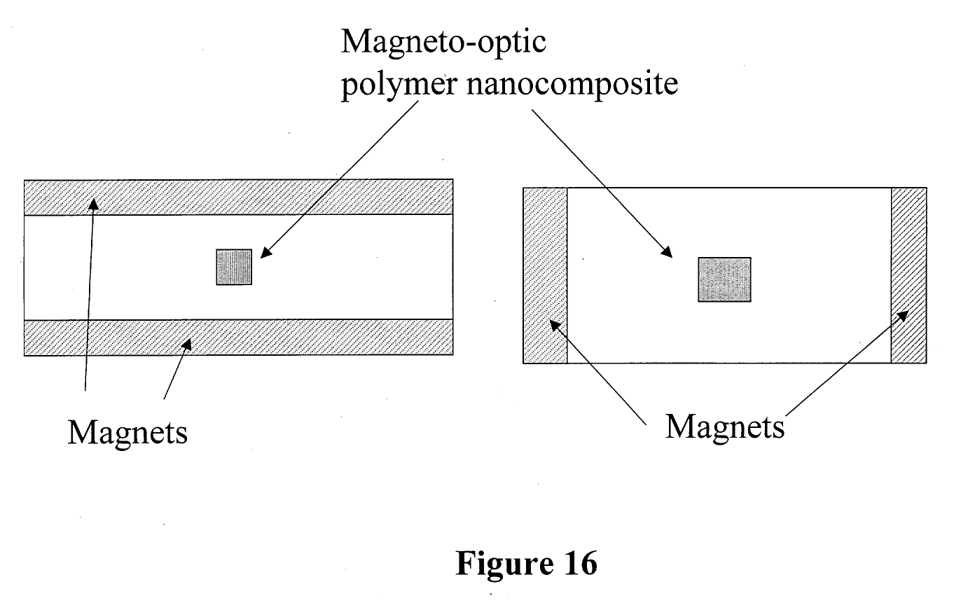

In another optical article as shown in FIG. 15, the input polarization with 90 degrees can be rotated to the output polarization with 0 degrees through the magneto-optic polymer nanocomposite according to the present invention. In addition, the relative position of the magneto-optic polymer nanocomposite and magnets are shown, for example, in FIG. 16, in optical articles according to the present invention.

The quality of the magneto-optic polymer nanocomposites can be improved by application of various processing techniques, for example, magnetic annealing, or aligning. In this process, the magnetic field is applied to the polymer nanocomposite as it cools through a certain temperature range usually about the glass transition temperature of the polymer host. The material can then exhibit a uniaxial alignment of the magneto-optic response determined by the direction of the applied magnetic field.

Optical isolators can be made with the magneto-optic polymer nanocomposite materials that are disclosed in this invention. In one embodiment of the invention, the polymer nanocomposite can be utilized in bulk form. The polymer nanocomposite magneto-optic article can be formed by bulk polymer-compatible processes, such as injection molding, extrusion, or stamping. The nanocomposite magneto-optic article can be aligned with the surrounding peripheral components, such as the magnets, polarization splitters, and polarizers.

In another embodiment, the polymer nanocomposite magneto-optic article can be fabricated into a thin film by standard thin film processing techniques, such as spin-coating, dipping, or spraying. Optical slab or channel waveguides can be formed with the spin-coated thin-film by photolighographic and etching processes. Magneto-optic channel waveguide described in the present invention can have the form of buried channel waveguide, rib waveguide, or slab waveguide. Peripheral components, such as magnets, polarization splitters, waveplates, and polarizers can be formed surrounding the magneto-optic waveguide channels.

The invention is illustrated in greater detail in the following examples, which are non-limiting in nature.

### EXAMPLE 1

Synthesis of Neodymium Doped Yttrium Orthovanadate (YVO₄)

A 300 ml stainless steel Parr reactor equipped with a magnetic stir drive, pressure transducer, and glass liner was used to produce the nanoparticles. Yittrium acetate (7.64 g), vanadium (III) acetylacetonate (10.06 g), and 0.40 g neodymium isopropoxide were placed into the glass liner followed by the addition of 110 ml of 1,4-butanediol. An additional 40 ml of 1,4-butanediol was placed in the gap between the autoclave cylinder and the glass liner. The autoclave was heated to 300° C. for 3 hours. The reactor was cooled to room temperature, and the reactor solution was centrifuged. The sediment part was repeatively rinsed with methanol. The resulting supernatant was milky white and the nanoparticles could be separated out using 10 ml of concentrated ammonium hydroxide solution to 50 ml of supernatant. The resulting particles were browinish/black in color.

### EXAMPLE 2

Synthesis of Bismuth Doped Yttrium Iron Garnet (Bi—YIG)

Example 2(a): According to one method, a mixture of bismuth(III) acetate, yttrium(III) isopropoxide, and iron(III) n-butoxide was dissolved in a 160 ml of toluene in a test tube, where the ratio of the cations corresponded to the composition of Bi_{1.8}Y_{1.2}Fe₅O₁₂. The mixture was loaded into a 500 ml autoclave. An additional 40 ml of toluene was placed in the gap between the test tube and the autoclave wall. The autoclave was thoroughly purged with nitrogen, heated to a desired temperature (200°-300° C.) at a rate of 2.5°/min and kept at that temperature for 2 h. Autogenous pressure gradually increased as the temperature was increased and usually reached 3 MPa at 300° C. After the autoclave treatment, the resulting powders were washed repeatedly with acetone and dried in air. The powder was suspended in a 160 ml of 1,4-butanediol and treated thermally in a similar way to that described above. Autogenous pressure reached 2 MPa at 300° C. The product was then washed with acetone repeatedly and dried in air.

Example 2(b): According to another method, the Bi—YIG nanoparticles were prepared by coprecipitation and heat treatment processes. Aqueous solutions of nitrates of Bi, Y and Fe were mixed where the ratio of the cations corresponded to the composition of Bi_{1.8}Y_{1.2}Fe₅O₁₂. Then the solution was mixed with a NH₄OH solution with stirring at room temperature. The obtained slurry was washed, filtered and dried at 100° C. for 2 h. Then the coprecipitate was heated in air for 4 h. The temperatures of the heat treatments were from 550 to 700° C.

### EXAMPLE 3

Formation of Polymer Nanocomposite

The magneto-optical nanoparticles, such as YVO₄ or Bi—YIG, were dispersed into a polar solvent such as benzonitrile using high power sonicator (700 watts). A solution of poly(9-vinylcarbazole) dissolved in benzonitrile was added to the nanoparticles solution forming a final mixture with at least 5 wt % of nanoparticles in polymer.

The polymer/nanoparticles solution was spin-coated on to a silicon substrate at 2000 rpm for 30 sec. The film was dried at 80° C. for 30 min, 120 C. for 30 min and then 180° C. for 2 hours.

What is claimed is:

1. A composite material comprising:
a host matrix, and
a plurality of magneto-optic nanoparticles within the host matrix.

2. The composite material according to claim 1, wherein at least one of said plurality of magneto-optic nanoparticles comprises at least one coating layer.

3. The composite material according to claim 2, wherein at least one of said plurality of magneto-optic nanoparticles comprises a halogenated outer coating layer.

4. The composite material according to claim 1, wherein said host matrix comprises at least one polymer.

5. The composite material according to claim 1, wherein the plurality of magneto-optic nanoparticles are distributed within said host matrix such that the composite exhibits magneto-optic properties.

6. The composite material according to claim 1, wherein said host matrix is chosen from halogenated elastomers, perhalogenated elastomers, halogenated plastics, and perhalogenated plastics.

7. The composite material according to claim 1, wherein said host matrix comprises at least one entity chosen from polymers, copolymers, and terpolymers comprising at least one halogenated monomer chosen from monomers of one of the following formulas: 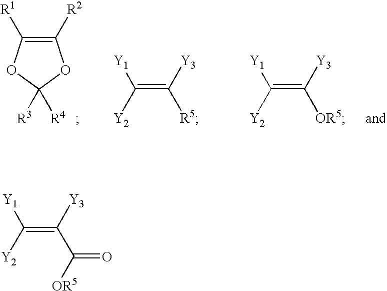
wherein;
R¹, R², R³, R⁴, and R⁵, which may be identical or different, are each chosen from linear and branched hydrocarbon-based chains, capable of forming at least one carbon-based ring, being saturated or unsaturated, wherein at least one hydrogen atom of the hydrocarbon-based chains may be halogenated; a halogenated alkyl, a halogenated aryl, a halogenated cyclic alky, a halogenated alkenyl, a halogenated alkylene ether, a halogenated siloxane, a halogenated ether, a halogenated polyether, a halogenated thioether, a halogenated silylene, and a halogenated silazane;
Y₁ and Y₂, which may be identical or different, are chosen from H, F, Cl, and Br atoms; and
Y₃ is chosen from H, F, Cl, and Br atoms, CF₃, and CH₃.

8. The composite material according to claim 7, wherein at least one of R¹, R², R³, R⁴, and R⁵ is at least partially fluorinated.

9. The composite material according to claim 7, wherein at least one of R¹, R², R³, R⁴, and R⁵ is completely fluorinated.

10. The composite material according to claim 7, wherein at least one of R¹, R², R³, R⁴, and R⁵ is chosen from C₁-C_{10,} linear and branched, saturated and unsaturated, hydrocarbon-based chains.

11. The composite material according to claim 1, wherein said host matrix comprises at least one polymer condensation product of at least one of the following monomeric reactions:
HO—R—OH+NCO—R′—NCO;
and
HO—R—OH+Ary¹-Ary²,
wherein;
R and R′, which may be identical or different, are chosen from halogenated alkylenes, halogenated siloxanes, halogenated ethers, halogenated silylenes, halogenated arylenes, halogenated polyethers, and halogenated cyclic alkylenes; and
Ary¹ and Ary², which may be identical or different, are chosen from halogenated aryls and halogenated alkyl aryls.

12. The composite material according to claim 1, wherein said host matrix comprises at least one material chosen from halogenated polycarbonates, halogenated cyclic olefin polymers, halogenated cyclic olefin copolymers, halogenated polycyclic polymers, halogenated polyimides, halogenated polyether ether ketones, halogenated epoxy resins, and halogenated polysulfones.

13. The composite material according to claim 1, wherein said host matrix comprises a combination of two or more different fluoropolymer materials.

14. The composite material according to claim 1, wherein said polymer host matrix further comprises at least one halogenated polymer comprising at least one functional group chosen from phosphinates, phosphates, carboxylates, silanes, siloxanes, and sulfides.

15. The composite material according to claim 14, wherein the at least one functional group is chosen from POOH, POSH, PSSH, OH, SO₃H, SO₃R, SO₄R, COOH, NH₂, NHR, NR₂, CONH₂, and NH—NH₂, wherein R is chosen from linear and branched hydrocarbon-based chains, capable of forming at least one carbon-based ring, being saturated or unsaturated; alkylenes, siloxanes, silanes, ethers, polyethers, thioethers, silylenes, and silazanes.

16. The composite material according to claim 1, wherein said host matrix comprises at least one material chosen from homopolymers and copolymers of monomeric units chosen from vinyl, acrylate, methacrylate, vinyl aromatic, vinyl ester, alpha beta unsaturated acid ester, unsaturated carboxylic acid ester, vinyl chloride, vinylidene chloride, and diene monomers.

17. The composite material according to claim 1, wherein said host matrix comprises at least one hydrogen-containing fluoroelastomer.

18. The composite material according to claim 1, wherein said host matrix comprises at least one cross-linked halogenated polymer.

19. The composite material according to claim 18, wherein said at least one cross-linked halogenated polymer comprises at least one fluorinated polymer.

20. The composite material according to claim 1, wherein said host matrix comprises at least one perhalogenated polymer.

21. The composite material according to claim 20, wherein the at least one perhalogenated polymer is chosen from perfluorinated polymers.

22. The composite material according to claim 1, wherein said host matrix comprises at least one perhalogenated elastomer.

23. The composite material according to claim 1, wherein said host matrix comprises at least one hydrogen-containing perfluoroelastomer.

24. The composite material according to claim 1, wherein said host matrix comprises at least one hydrogen-containing fluoroplastic.

25. The composite material according to claim 1, wherein said host matrix comprises at least one hydrogen-containing perfluorothermoplastic.

26. The composite material according to claim 1, wherein said host matrix comprises a blend of at least one material chosen from halogenated, fluorinated, and perfluorinated polymers.

27. The composite material according to claim 1, wherein said host matrix comprises at least one entity chosen from poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl)perfluorotetrahydrofuran], and poly[2,2,4-trifluoro-5-trifluoromethoxy-1,3-dioxole-co-tetrafluoroethylene].

28. The composite material according to claim 1, wherein said host matrix comprises at least one entity chosen from poly(pentafluorostyrene), fluorinated polyimide, fluorinated polymethylmethacrylates, and polyfluoroacrylates.

29. The composite material according to claim 1, wherein said host matrix comprises polyfluorostyrene.

30. The composite material according to claim 1, wherein said host matrix comprises fluorinated polycarbonates.

31. The composite material according to claim 1, wherein said host matrix comprises at least one perfluoro-polycyclic polymer.

32. The composite material according to claim 1, wherein said host matrix comprises at least one fluorinated cyclic olefin polymer.

33. The composite material according to claim 1, wherein said host matrix comprises at least one fluorinated copolymer of cyclic olefins.

34. The composite material according to claim 1, wherein at least one of said plurality of magneto-optic nanoparticles comprises at least one material having Verdet coefficient equal to or greater than 0.2 degree/mT·μm.

35. The composite material according to claim 34, wherein at least one of said plurality of magneto-optic nanoparticles comprises at least one material chosen from transition metal elements, rare-earth metal elements, the actinide element uranium, group VA elements, semiconductor materials, and group IVA elements in a form chosen from ions, alloys, compounds, composites, complexes, chromophores, dyes, and polymers.

36. The composite material according to claim 35, wherein the at least one material is chosen from YVO₄, TbPO₄, HoYbBiIG, (Cd,Mn,Hg)Te, MnAs, Y_{2.82} Ce_{0.18}Fe₅O₁₂, Bi-substituted iron garnet, yttrium iron garnet, terbium gallium garnet, lithium niobate, and paramagnetic rare-earth ions.

37. The composite material according to claim 36, wherein the paramagnetic rare-earth ions are chosen from Tb⁺³, Y⁺³, and Ce⁺³.

38. The composition material according to claim 1, wherein at least one of the plurality of magneto-optic nanoparticles has a Faraday effect.

39. The composite material according to claim 35, wherein the semiconductor materials are chosen from Si, PbS, Ge, GaP, GaAs, InP, InAs, InSb, PbSe, and PbTe.

40. The composite material according to claim 35, wherein at least one of said plurality of magneto-optic nanoparticles comprises at least one material chosen from precious metals and alloys thereof.

41. The composite material according to claim 40, wherein the precious metals are Ag.

42. The composite material according to claim 1, wherein at least one of said plurality of magneto-optic nanoparticles comprises at least one material having an index of refraction ranging from about 1 to about 5.

43. The composite material according to claim 42, wherein at least one of said plurality of magneto-optic nanoparticles comprises at least one material having an index of refraction ranging from about 1.5 to about 4.5.

44. The composite material according to claim 35, Wherein at least one of said plurality of magneto-optic nanoparticles comprises at least one material chosen from dye nanoparticles.

45. The composite material according to claim 35, wherein at least one of said plurality of magneto-optic nanoparticles comprises at least one material chosen from lithium niobate, non-linear optical chromophores, and organic dyes.

46. The composite material according to claim 35, wherein at least one of said plurality of magneto-optic nanoparticles further comprises at least one material chosen from paramagnetic, ferromagnetic, antiferromagnetic, ferromagnetic, and diamagnetic materials.

47. The composite material according to claim 1, wherein at least one of said plurality of magneto-optic nanoparticles comprises at least one polymer.

48. The composite material according to claim 47, wherein said at least one polymer comprises at least one functional group chosen from POOH, POSH, PSSH, OH, SO₃H, SO₃R, SO₄R, COOH, NH₂, NHR, NR₂, CONH₂, and NH—NH₂, wherein R is chosen from linear and branched hydrocarbon-based chains, capable of forming at least one carbon-based ring, being saturated or unsaturated, alkylenes, siloxanes, silanes, ethers, polyethers, thioethers, silylenes, and silazanes.

49. The composite material according to claim 47, wherein said at least one polymer is chosen from homopolymers and copolymers of monomeric units chosen from vinyl, acrylic, vinyl aromatic, vinyl esters, alpha beta unsaturated acid esters, unsaturated carboxylic acid esters, vinyl chloride, vinylidene chloride, and diene monomers.

50. The composite material according to claim 1, wherein a majority of said plurality of magneto-optic nanoparticles has a major dimension of less than about 50 nm.

51. The composite material according to claim 1, wherein said plurality of magneto-optic nanoparticles further comprises a first group of nanoparticles comprising at least one active material of a first type and at least a second group of nanoparticles comprising at least one active material of a second type different from the first type.

52. The composite material according to claim 3, wherein the halogenated outer coating layer comprises at least one halogen chosen from fluorine, chlorine, and bromine.

53. The composite material according to claim 3, wherein the halogenated outer coating layer comprises at least one material chosen from halogenated polyphosphates, halogenated phosphates, halogenated phosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated thiols, and halogenated alkylcyanide.

54. The composite material according to claim 52, wherein the halogenated outer coating layer is fluorinated.

55. The composite material according to claim 3, wherein at least one of said plurality of magneto-optic nanoparticles further comprises at least one inner coating disposed beneath the halogenated outer coating layer, wherein the at least one inner coating is a passivation layer.

56. The composite material according to claim 3, wherein the halogenated outer coating layer comprises at least one material that reacts with and neutralizes at least one radical group on at least one of the plurality of magnetic-optic nanoparticles.

57. The composite material according to claim 56, wherein the at least one radical group is chosen from OH and esters.

58. The composite material according to claim 35, wherein the at least one of said plurality of magneto-optic nanoparticles further comprises at least one material chosen from lithium niobate, barium titinate, proustite, yttrium aluminate, rutile, and ziroconate and their counterparts doped with an ion chosen from rare-earth and transition metal ions.

59. The composite material according to claim 1, wherein the concentration of the said plurality of magneto-optic nanoparticles ranges from about 10 volume % to about 95 volume % of the composite material.

60. The composite material according to claim 1, wherein the index of refraction of the composite material ranges from about 1 to about 5.

61. An optical device comprising at least one composite material, comprising:
a host matrix, and
a plurality of magneto-optic nanoparticles within the host matrix.

62. The optical device according to claim 61, wherein the optical device is chosen from optical rotators, optical isolators, optical circulators, optical modulators, waveguides, and amplifiers.

63. The optical device according to claim 62, wherein the optical rotators are chosen from Faraday rotators.

64. The optical device according to claim 61, wherein at least one of the plurality of magneto-optic nanoparticles comprises at least one material having a Faraday effect.

65. The optical device according to claim 61, wherein at least one of the plurality of magneto-optic nanoparticles comprises a halogenated outer coating layer.

66. The optical device according to claim 61, wherein the host matrix comprises at least one material chosen from halogenated elastomers, perhalogenated elastomers, halogenated plastics, and perhalogenated plastics.

67. The optical device according to claim 66, wherein the host matrix comprises at least one material chosen from hydrogen-containing perfluoroelastomers, hydrogen-containing fluoroplastics, perfluorothermoplastics, blend of at least two different fluoropolymer materials, poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl)perfluorotetrahydrofuran, poly[2,2,4-trifluoro-5-trifluoromethoxy-1,3-dioxole-co-tetrafluoroethylene], poly(pentafluorostyrene), fluorinated polyimides, fluorinated polymethylmethacrylate, polyfluoroacrylates, polyfluorostyrene, fluorinated polycarbonates, perfluoro-polycyclic polymers, fluorinated cyclic olefin polymers, and fluorinated copolymers of cyclic olefins.

68. The optical device according to claim 61, wherein at least one of said plurality of magneto-optic nanoparticles comprises at least one polymer.

69. The optical device according to claim 65, wherein the halogenated outer coating layer comprises at least one halogen chosen from fluorine, chlorine, and bromine.

70. The optical device according to claim 65, wherein the halogenated outer coating layer comprises at least one material chosen from halogenated polyphosphates, halogenated phosphates, halogenated phosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated thiols, and halogenated alkylcyanide.

71. The optical device according to claim 65, wherein at least one of said plurality of magneto-optic nanoparticles further comprises at least one inner coating disposed beneath the halogenated outer layer coating layer, wherein the at least one inner coating comprises a passivation layer.

72. The optical device according to claim 61, wherein a majority of said plurality of magneto-optic nanoparticles has a major dimension of less than about 50 nm.

73. The optical device according to claim 61, wherein at least one of the plurality of magneto-optic nanoparticles comprises at least one material having a Verdet coefficient equal to or greater than 0.2 degree/mT·μm.

74. A thin-film magneto-optic article comprising at least one composite material, comprising:
a host matrix, and
a plurality of magneto-optic nanoparticles within the host matrix.

75. The thin-film magneto-optic article according to claim 74, wherein at least one of the plurality of magneto-optic nanoparticles comprises at least one material having a Faraday effect.

76. The thin-film magneto-optic article according to claim 74, wherein at least one of the plurality of magneto-optic nanoparticles comprises a halogenated outer coating layer.

77. The thin-film magneto-optic article according to claim 74, wherein the host matrix comprises at least one material chosen from halogenated elastomers, perhalogenated elastomers, halogenated plastics, and perhalogenated plastics.

78. The thin-film magneto-optic article according to claim 77, wherein the host matrix comprises at least one material chosen from hydrogen-containing perfluoroelastomers, hydrogen-containing fluoroplastics, perfluorothermoplastics, blend of at least two different fluoropolymer materials, poly[2,2-bistrifluoromethyl-4,5-difluoro-1,3-dioxole-co-tetrafluoroethylene], poly[2,2-bisperfluoroalkyl-4,5-difluoro-1,3-dioxole-co-tetrafluoroethylene], poly[2,3-(perfluoroalkenyl)perfluorotetrahydrofuran, poly[2,2,4-trifluoro-5-trifluoromethoxy-1,3-dioxole-co-tetrafluoroethylene], poly(pentafluorostyrene), fluorinated polyimides, fluorinated polymethylmethacrylate, polyfluoroacrylates, polyfluorostyrene, fluorinated polycarbonates, perfluoro-polycyclic polymers, fluorinated cyclic olefin polymers, and fluorinated copolymers of cyclic olefins.

79. The thin-film magneto-optic article according to claim 74, wherein at least one of said plurality of magneto-optic nanoparticles comprises at least one polymer.

80. The thin-film magneto-optic article according to claim 76, wherein the halogenated outer coating layer comprises at least one halogen chosen from fluorine, chlorine, and bromine.

81. The thin-film magneto-optic article according to claim 76, wherein the halogenated outer coating layer comprises at least one material chosen from halogenated polyphosphates, halogenated phosphates, halogenated phosphinates, halogenated dithiophosphinates, halogenated pyrophosphates, halogenated alkyl titanates, halogenated alkyl zirconates, halogenated silanes, halogenated alcohols, halogenated amines, halogenated carboxylates, halogenated amides, halogenated sulfates, halogenated esters, halogenated acid chloride, halogenated acetylacetonate, halogenated thiols, and halogenated alkylcyanide.

82. The thin-film magneto-optic article according to claim 76, wherein at least one of said plurality of magneto-optic nanoparticles further comprises at least one inner coating disposed beneath the halogenated outer layer coating layer, wherein the at least one inner coating comprises a passivation layer.

83. The thin-film magneto-optic article according to claim 74, wherein a majority of said plurality of magneto-optic nanoparticles has a major dimension of less than about 50 nm.

84. The thin-film magneto-optic article according to claim 74, wherein at least one of the plurality of magneto-optic nanoparticles comprises at least one material having a Verdet coefficient equal to or greater than 0.2 degree/mT·μm.

85. A process of forming a magneto-optic composite material, comprising:
coating a majority of a plurality of magneto-optic nanoparticles with a halogenated outer layer; and
dispersing the plurality of coated magneto-optic nanoparticles into a host matrix material.

86. The process according to claim 85, wherein the host matrix material comprises at least one polymer.

87. The process according to claim 86, wherein the host matrix material comprises at least one halogenated polymer.

88. The process according to claim 85, further comprising forming at least one passivation layer on a majority of the magneto-topic nanoparticles prior to coating each of the plurality of nanoparticles with a halogenated outer layer.

89. The process according to claim 85, wherein coating a majority of the magneto-optic nanoparticles further comprises:
forming the plurality of magneto-optic nanoparticles in the presence of a halogen-containing coating material, and
forming the halogenated outer layer on a majority of the magneto-optic nanoparticles in situ.

90. The process according to claim 85, wherein coating a majority of the magneto-optic nanoparticles further comprises dispersing the magneto-optic nanoparticles into a solution comprising a halogen-containing coating material.

91. The process according to claim 85, wherein coating the magneto-optic nanoparticles further comprises;
placing the magneto-optic nanoparticles into a solvent comprising materials for forming the halogenated outer layer; and
performing a chemical replacement reaction to substitute the halogenated outer layer for a preexisting coating on a majority of the plurality of magneto-optic nanoparticles.

92. The process according to claim 85, wherein the dispersing comprises:
co-dissolving the magneto-optic nanoparticles and the host matrix material in a solvent to form a solution;
spin coating the solution onto a substrate; and
evaporating the solvent from the solution.

93. The process according to claim 85, wherein the host matrix material is a monomer host matrix.

94. The process according to claim 93, further comprising polymerizing the monomer after dispersing the magneto-optic nanoparticles in the host matrix material.

95. A composite material comprising:
a halogenated polymer host matrix;- and
a plurality of magneto-optic nanoparticles within the halogenated polymer host matrix.

96. An optical component comprising:
a host matrix; and
a plurality of magneto-optic nanoparticles within the host matrix.

97. The optical component according to claim 96, wherein the optical component is an integrated optical component.
